(19) United States
(12) Patent Application Publication
(10) Pub. No.: US 2016/0084805 A1
(43) Pub. Date: Mar. 24, 2016

(54) SYSTEM AND METHOD OF PRECONCENTRATING ANALYTES IN A MICROFLUIDIC DEVICE

(71) Applicants: Ryan T. Kelly, West Richland, WA (US); Yongzheng Cong, Richland, WA (US)

(72) Inventors: Ryan T. Kelly, West Richland, WA (US); Yongzheng Cong, Richland, WA (US)

(73) Assignee: BATTELLE MEMORIAL INSTITUTE, Richland, WA (US)

(21) Appl. No.: 14/958,248

(22) Filed: Dec. 3, 2015

Related U.S. Application Data
(63) Continuation-in-part of application No. 14/495,674, filed on Sep. 24, 2014.
Application No. 14/495,674 is a continuation-in-part of application No. 14/264,385, filed on Apr. 29, 2014.
Application No. 14/264,385 is a continuation-in-part of application No. 13/596,360, filed on Aug. 28, 2012.
Application No. 13/596,360 is a division of application No. 12/889,108, filed on Sep. 23, 2010, now Pat. No. 8,277,659.

(51) Int. Cl. G01N 30/08; H01J 49/16; G01N 27/447

(52) U.S. Cl. CPC G01N 30/08; G01N 27/44791; G01N 27/44743; H01J 49/167; G01N 2030/027

(57) ABSTRACT

A method and system for preconcentrating analytes at a microvalve in a microfluidic device is disclosed. The system includes a sample channel loaded with a sample solution. The sample channel includes a semi-permeable membrane microvalve. An electric potential is applied at or across the microvalve to preconcentrate the sample solution when the microvalve is closed. The method includes pretreatments of the device or valve for preconcentration of the analytes. For preconcentration of anionic analytes, the device is baked. For preconcentration of the cationic analytes, the surface of the membrane microvalve is coated with a polycationic coating, and the device is baked.

### CROSS-REFERENCE TO RELATED APPLICATIONS

This application is a continuation-in-part of co-pending U.S. patent application Ser. No. 14/495,674, filed on Sep. 24, 2014, which is a continuation-in-part of co-pending U.S. patent application Ser. No. 14/264,385, filed on Apr. 29, 2014, which is a continuation-in-part of co-pending U.S. patent application Ser. No. 13/596,360, filed on Aug. 28, 2012, which is a divisional of Issued U.S. Pat. No. 8,277,659, filed on Sep. 23, 2010, the disclosures of which are hereby incorporated by reference herein.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### TECHNICAL FIELD

This invention relates to microfluidic devices. More specifically, this invention relates to preconcentrating analytes at a microvalve, as a semi-permeable membrane, in a microfluidic device by applying an electric potential at or across the microvalve.

### BACKGROUND

When performing microchip capillary electrophoresis (CE), sample introduction and injection can significantly affect CE performance. Currently, electrokinetic injection is used almost exclusively for microchip CE sample injection. In a particular type of electrokinetic injection known as “pinched” injection, various electrodes in a first mode apply voltages in four intersecting channels to drive sample through the intersection to a waste reservoir. In a second mode, the voltages induce injection of only a plug of sample occupying the small volume in the intersection towards a separation channel. The voltage applied to the separation channel is different in the first mode, wherein sample is diverted to waste, compared to the second mode, wherein the plug of sample is injected into the separation channel. Except for the sample plug, the vast majority of sample is wasted.

While electrokinetic injection can yield small sample plugs for improved separation efficiency and can minimize electrophoretic injection bias under certain conditions, it also has several significant limitations. For example, a considerable amount of time is required to achieve steady state in the first mode. Steady state is a necessary condition to avoid sample bias and/or injection bias caused by high mobility species arriving more quickly than low mobility species. During prolonged operation, the high mobility species can be depleted preferentially and prematurely from the sample supply. Sample utilization is extremely inefficient because the total volume required is very large compared to the actual injected plug volume, which is very small. Furthermore, the injection volume is fixed because it is determined by the geometry of the intersection. In order to change the injection volume, the geometry of the intersection must typically be altered. Further still, the rate at which sequential injections can be analyzed, and the total number of sample plugs that can be injected into the separation channel, is limited by the steady-state flow requirements and by the changing voltages in the separation channel associated with electrokinetic injection.

In view of at least the limitations described above, a need for an improved sample injector for separation analysis exists.

CE is widely used for bioanalytical analyses and noteworthy for its ability to achieve extremely high resolution separations in short periods of time. One challenge for CE is that to achieve high resolution, a very small volume sample plug must be injected, which poses a challenge for detection of dilute analytes. This has prompted at least two decades of efforts to develop preconcentration strategies for CE. Such efforts include field amplified stacking, sweeping, isotachophoresis, and solid phase microextraction. Unfortunately, each one of these concentration methods negatively impacts the resolution that can be achieved in the CE separation.

For highly complex samples such as in proteomics, the peak capacity of the separation directly correlates with the number of analytes that can be identified. A hybrid separation consisting of liquid chromatography (LC) coupled with CE is highly attractive for ultrahigh peak capacity separations, as the two separation mechanisms are highly orthogonal so the peak capacities from each dimension should multiply together to provide an exceptionally high overall peak capacity. To date, efforts to couple LC and CE has involved transferring only a small portion of the sample from LC to CE, while the rest of the LC eluent was wasted. The peak capacity gains achieved in the multidimensional separation have been offset by a large loss in sensitivity resulting from the poor analyte utilization efficiency. As such, no gain in coverage relative to single dimension separations has been realized.

A need exists to solve the issue of preconcentrating analytes without degrading resolution as well as enable multidimensional separations with total analyte utilization.

### SUMMARY

The present invention is a microfluidic injector system based on a mechanical valve rather than electrokinetic injection. The injector system comprises a port configured to interface with a discrete separation column connected to the injector system via the port. The mechanical valve can be operated to provide rapid sequential sample injections and to eliminate the need for changing the electric field in an attached separation column to induce sample injection. Instead, sample injection is accomplished by pressure gradients and by opening the mechanical valve. A constant electric field can, therefore, be continuously applied along the separation channel. Varying the sample pressure and/or the duration of time that the valve remains in an open position can vary sample injection volume. Depending on the type and configuration of the separation column attached to the microfluidic injector, various kinds of separations and analytical techniques can be performed. The terminal end of the separation column can also be configured to enable different analyses. For example, an electrospray ionization (ESI) emitter can be arranged at the end of the separation column. Furthermore, mass spectrometry can be performed to analyze the sample after CE separation.

For sample introduction using the embodiments described herein, it can be advantageous, though not required, for the introduced sample to displace fluid in the sample loading channel preferentially to the side of the sample channel opposite the separation column. This increases probability that the introduced sample does not disturb an ongoing separation in the separation column. If the introduced sample alternatively displaces fluid towards, or into, the separation column, it may degrade a separation already underway inside the separation column, as the pressure pulse from the injection may induce broadening of the separated peaks. This condition will likely automatically be met when the separation column contains packed particles, monolithic material, a cross-linked gel or a viscous polymer solution as these materials in the separation column increase its back pressure substantially. In one embodiment involving an open tubular separation column, it is important to ensure that the backpressure in the separation column is at least 10 times greater than the backpressure of the sample loading channel on the side opposite the separation column. This can be achieved by ensuring that the ratio of the length of the separation column to its cross-sectional area is at least 10 times greater than the ratio of the length of the sample loading channel on the side opposite the separation column to its cross-sectional area.

In one embodiment, a microfluidic injector system comprises a flow layer having a first sample channel connected in a T-shaped arrangement to a loading channel at a first intersection, wherein the first sample channel has a source of pressure and is configured to maintain a sample pressure greater than that of the loading channel at the first intersection. The loading channel has a terminus comprising a port configured to interface with a separation column. The system further comprises a control layer comprising a valving channel, wherein the valving channel in the control layer crosses over the first sample channel in the flow layer at or near the first intersection. The system also comprises a mechanical valve, not an electrokinetic-based injector, to control a sample injection from the first sample channel into the loading channel, the mechanical valve comprising a deformable membrane between the control layer and the flow layer and separating the valving channel and the first sample channel, wherein the membrane has a closed position to obstruct flow in the first sample channel, and an open position to permit flow in the first sample channel based on a first and second pressure, respectively, in the valving channel.

In some embodiments, the system comprises one or more CE electrodes arranged along the loading channel and configured to continuously apply an electric field for CE separation. Additional CE electrodes can be arranged along an attached separation column and can be configured to continuously apply an electric field for CE separation. As used herein, the continuous application of an electric field along the loading channel and/or separation column for CE separation is significant because any sample injection provided to the separation channel will be subject to a continuously applied CE separation field. There is no required change in voltage between an injection mode and a CE separation mode.

A sample channel is connected to the loading channel at an intersection and has a sample pressure that is greater than that which is present in the loading channel near the intersection. The sample channel does not have electrodes that apply voltages for electrokinetic injection. A sample injector in the sample channel, or at the intersection, comprises a mechanical valve to control sample injection from the sample channel to the loading channel. When the valve is opened for a short time, a small volume of sample solution is pushed into the separation channel under a low pressure. When the valve is closed, the sample solution is completely isolated from the run buffer in the loading channel such that there is no risk of sample leakage during the operation, and a discrete, well defined sample plug is injected with each valve opening event.

In some embodiments, the system comprises a plurality of sample sources connected to the first sample channel via a manifold. Valves and/or fluid flow controllers can be utilized to select which sample source, or combination of sources, provides an injection through the sample channel. In other embodiments, the system comprises at least one additional sample channel connected in a T-shaped arrangement to the loading channel at the first intersection or at an additional intersection. The additional sample channel is configured to maintain a sample pressure greater than that of the loading channel at the first or additional intersection. An additional valving channel for each additional sample channel can also exist. The additional valving channel in the control layer can cross over the additional sample channel in the flow layer at or near the first intersection or the additional intersection. An additional mechanical valve, not an electrokinetic-based injector, for each additional sample channel can control sample injection from the additional sample channel into the loading channel. The additional mechanical valve comprises a deformable membrane between the control layer and the flow layer and separates the additional valving channel and the additional sample channel. The additional membrane has a closed position to obstruct flow in the additional sample channel, and an open position to permit flow in the additional sample channel based on a first and second pressure, respectively, in the additional valving channel.

In embodiments having a first sample source connected to the first sample channel and an additional sample source connected to the additional sample channel, the first sample source can contain an analyte or an analyte precursor while the additional sample source can contain an analyte-derivatizing reactant or an analyte precursor. The injection from the first and additional sample channels can mix and/or react in the loading channel. If the positions of the first and additional sample channels are offset, or they occur at differing positions of the loading channel, then the injections can be timed appropriately to facilitate the desired degree of mixing of the plurality of injections.

Examples of the analyte-derivatizing reactant can include, but are not limited to radiolabels, fluorescent labels, labels to enhance electrospray ionization efficiency, and reactants that alter the charge state of the analyte.

A significant characteristic of the system is that the sample injection is independent of the separation technique. For example, during CE operation, a high voltage is applied only along the loading channel and/or separation column and no voltage switching is needed. The sample is directly provided into the loading channel and/or separation column for subsequent separation. There is no need to wait for production of a steady-state, stable sample plug as would be required in the traditional electrokinetic injection. Discrete sample plugs can be injected repeatedly over relatively long periods of time. The injection and separation frequency is only determined by the actuation of the mechanical valve. A valve having a high duty cycle makes it possible to perform continuous flow monitoring, high throughput analysis, and/or multiplexed separations. Systems having multiple sample channels with multiple sample sources and discrete valves can enable many combinations of sample injections and combinations.

Embodiments of the present invention can further comprise a plurality of discrete injections of samples from one or more sample channels to the loading channel in a rapid sequence. The sequence can preferably be pseudo-random. A detector at the end of a separation column attached to the loading channel through an interface can detect the discrete injections after CE-induced overlap, which comprises mixing of at least one component from at least one of the discrete injections to another discrete injection. A processing device executes programming to deconvolute the CE-induced overlap in data collected by the detector so that a spectrum can be reconstructed.

Some embodiments can further comprise a plurality of separation columns as well as a manifold at or near the interface between the loading channel and the separation columns. The manifold comprises a conduit that transitions from a single fluid flow line to multiple flow lines and distributes the flow of sample injections among the multiple flow lines. Each flow line can proceed to a separation column. Preferably, an electrospray ionization (ESI) emitter is connected at the end of each separation column.

In some embodiments, sample injections from the microfluidic injector systems have a volume less than 10 nL. In other embodiments, the volume is less than 1 nL. In still other embodiments, the volume is less than 200 pL.

The separation column, as used herein, can refer to a capillary or another tube. In one embodiment, the separation column can have an inner dimension that is as small as 10 micrometers and which may be as large as 5 millimeters. The separation column may be an open tube filled with an electrolyte solution for performing capillary zone electrophoresis separations. The column may also be filled with a viscous polymer solution, a cross-linked gel or another medium for performing sieving-based separations (e.g., capillary gel electrophoresis). The separation column may also be filled with chromatographic media in the form of particles or with a monolithic material having chemical properties such that, e.g., capillary electrochromatography can be performed using the column. Other suitable examples are encompassed by the present invention though they are not listed herein.

In some embodiments, liquid chromatography (LC) separation is performed in conjunction with CE separation. Accordingly, the system can further comprise a LC column connected to a sample channel and can provide LC separation prior to injection into the loading channel.

Embodiments of the present invention also include methods for analyzing a sample having a plurality of components using CE separation. In a particular embodiment, the method includes the steps of applying a sample pressure in the sample channel greater than the sample pressure in a separation channel. The sample channel is connected to the separation channel at an intersection and lacks electrodes associated with electrokinetic-based injectors. A continuous electric field for CE separation is applied along the separation channel. Injection of the sample occurs by mechanically opening for a duration a mechanical valve, not an electrokinetic-based injector. The mechanical valve is located in the sample channel or at the intersection. The electric field in the separation channel can then separate the components in the injection.

The method can further comprise repeating the mechanical opening in a rapid, pseudo-random sequence to provide a plurality of discrete injections of the sample from the sample channel to the separation channel. CE-induced overlap can be the result of mixing at least one component from at least one of the discrete injections with another discrete injection. The discrete injections are then detected at the end of the separation channel after CE-induced overlap. Finally, the CE-induced overlap in data collected by the detector is deconvoluted so that a spectrum can be reconstructed.

Alternatively, the method can further include distributing one or more injections among a plurality of CE channels within the separation channel. In preferred embodiments, an electrospray can be generated at the end of each CE channel.

In another embodiment, LC separations can be performed in conjunction with the CE separations. Accordingly, the method can further comprise separating the sample in a liquid chromatography column prior to providing an injection to the separation channel.

In another embodiment of the present invention, a system for preconcentrating analytes at a microvalve in a microfluidic device is disclosed. The system includes a sample channel loaded with a sample solution. The sample channel includes a semi-permeable membrane microvalve. The system also includes an electric potential applied at or across the microvalve to preconcentrate the sample solution when the microvalve is closed. When the microvalve is closed, the sample solution cannot freely flow through the sample channel. When the microvalve is open, the sample solution can freely flow through the sample channel. The microvalve may be pressure actuated, mechanically actuated, or electrically actuated.

In one embodiment, the applied voltage or potential at or across the membrane is between 100 and 5000 volts. In one embodiment, the buffer solution is between 1 and 500 millimolar. In one embodiment, the thickness of the membrane is less than about 100 micrometers.

In one embodiment, the sample channel is coupled to a second channel downstream of the sample channel. The sample solution is introduced into the second channel when the microvalve is open.

In one embodiment, the second channel is a flow channel. The flow channel may be, but is not limited to, a separation channel.

In one embodiment, the sample solution is simultaneously preconcentrated in the sample channel and separated in the separation channel when the microvalve is closed. In one embodiment, the sample channel intersects the separation channel in a T-junction configuration.

In one embodiment, the system further includes a control channel that crosses the sample channel at an intersection upstream of the T-junction intersection. In this embodiment, the microvalve can be positioned at the intersection of the control channel and the sample channel.

The system may further include a buffer solution that is introduced into the separation channel along with the sample solution. In one embodiment, the sample solution displaces the buffer solution in the separation channel.

The system may also include a plurality of electrodes arranged along the separation channel. An electric field is applied by the electrodes for capillary electrophoresis separations.

The system may also include a liquid chromatography column coupled to and upstream of the sample channel, and an electrospray ionization (ESI) source coupled at one end of the separation channel.

In another embodiment of the present invention, a method of preconcentrating analytes at a microvalve in a microfluidic device is disclosed. The method includes loading sample solution into a sample channel, wherein the sample channel includes a semi-permeable membrane microvalve. The method also includes applying an electric potential at or across the microvalve to preconcentrate the sample solution when the microvalve is closed.

In another embodiment of the present invention, a system for preconcentrating analytes at a microvalve in a microfluidic device is disclosed. The system includes a sample channel for loading a sample solution into a flow channel. The sample channel includes a microvalve with a semipermeable membrane. The system also includes an electric potential applied at or across the microvalve to preconcentrate the sample solution when the membrane microvalve is closed.

In another embodiment of the present invention, a method of preconcentrating analytes at a microvalve in a microfluidic device is disclosed. The method includes loading a sample solution from a sample channel into a flow channel. The sample channel includes a microvalve with a semipermeable membrane. The method also includes applying an electric potential at or across the microvalve to preconcentrate the sample solution when the membrane microvalve is closed.

In another embodiment of the present invention, a system for preconcentrating analytes at a microvalve in a microfluidic device is disclosed. The system includes a sample channel for loading a sample solution into a flow channel. The sample channel includes a microvalve with a semipermeable membrane. The system also includes an electric potential applied at or across the microvalve to preconcentrate the sample solution when the membrane microvalve is closed.

In one embodiment, the system may further include a capillary holder coupled to the separation channel, for positioning a tapered or etched end of a capillary into the separation channel such that the interface between the capillary and the separation channel is free of dead volume or substantially free of dead volume. In one embodiment, a concentration of the sample solution is less than about 100 millimolars.

In another embodiment of the present invention, a method of preconcentrating cationic analytes at a semi-permeable membrane microvalve positioned in a sample channel of a microfluidic device is disclosed. The method includes coating a surface of the microvalve with a polycationic polymer; baking the device at a temperature range of approximately 100 to 150° C.; loading a sample solution into the sample channel, wherein a concentration of the sample solution is less than about 100 millimolars; and applying an electric voltage at or across the microvalve to preconcentrate the sample solution when the microvalve is closed. In one embodiment, the method may further include positioning a tapered or etched end of a capillary into the separation channel such that the interface between the capillary and the separation channel is free of dead volume.

In another embodiment of the present invention, a method of preconcentrating anionic analytes at a microvalve positioned in a sample channel of a microfluidic device is disclosed. The method includes baking the device at a temperature range of approximately 100 to 150° C.; loading a sample solution into the sample channel, wherein a concentration of the sample solution is less than about 100 millimolars; and applying an electric voltage at or across the microvalve to preconcentrate the sample solution when the microvalve is closed. In one embodiment, the method further comprises positioning a tapered or etched end of a capillary into the separation channel such that the interface between the capillary and the separation channel is free of dead volume.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### BRIEF DESCRIPTION OF THE DRAWINGS

Embodiments of the invention are described below with reference to the following accompanying drawings.

FIGS. 1A and 1B include diagrams of a microchip CE system A) having two layers according to one embodiment of the present invention and B) having three layers according to another embodiment.

FIG. 2 is a diagram depicting a microchip CE system using pressure injection and a pneumatic valve according to one embodiment of the present invention.

FIG. 3 is a sequence of micrographs depicting one cycle of sample injection.

FIGS. 4A-4D include graphs of fluorescence intensity as a function of time for four repeatable injection results at frequencies of 0.21 Hz, 0.43 Hz, 1.1 Hz, and 2.2 Hz, respectively.

FIGS. 5A-5D include graphs of peak width as a function of various operating parameters, including valve actuation time, sample injection pressure, valve control pressure, and valve actuation frequency, respectively.

FIG. 6 is a graph of fluorescence intensity as a function of time and shows a CE separation of four FITC-labeled amino acids using embodiments of the present invention.

FIG. 7 is a graph showing repeated CE separation of three FITC-labeled amino acids.

FIGS. 8A-8C include graphs showing portions of FIG. 7 in greater detail after varying numbers of runs.

FIG. 9 is a diagram depicting one embodiment in which the separation channel comprises a plurality of CE channels.

FIGS. 10A-10E are illustrations depicting various configurations and operational aspects of microfluidic sample injectors according to embodiments of the present invention.

FIG. 11 is a series of time-elapse images showing a pressure-driven injection sequence using one embodiment of a microfluidic sample injector described herein.

FIG. 12 is a graph showing the number of theoretical plates as a function of separation potential in CE separation following injection according to embodiments of the present invention.

FIG. 13 depicts a series of repeated separations of a three-peptide mixture containing kemptide, angiotensin II and leucine encephalin using embodiments of the present invention wherein the valve opening time is changed for each successive separation.

FIGS. 14A-C present data depicting the tradeoff between separation efficiency and S/N as the injection volume is varied. In 14A, three different pressures are applied at the sample loading channel to provide flow for electrospray ionization.

FIG. 15 is a graph depicting the peak area for three different peptides in a mixture over a range of injection times using embodiments of the present invention.

FIG. 16 is a schematic depicting one embodiment of a system for preconcentrating analytes at a microvalve in a microfluidic device, in accordance with one embodiment of the present invention.

FIGS. 17A-E are images showing the preconcentration of a cationic crystal violet molecule (FIGS. 17A-B) and preconcentration followed by injection of a anionic fluorescein molecule (FIGS. 17C-E), demonstrated in a set-up similar to the system shown in FIG. 16.

FIGS. 18A-C are images showing the preconcentration using different concentrations of the sample solution, with the sample concentration being 1 μM FITC labeled leucine enkephalin in 8 mM (FIG. 18A), 2 mM (FIG. 18B), and 0.5 mM (FIG. 18C) sodium carbonate with 0.5% hydroxypropyl cellulose (HPC).

FIG. 19 is a plot of current vs. voltage for closed microvalves on three different devices.

FIG. 20 shows MS signal intensity of leucine enkephalin vs. concentrating time.

FIG. 21 is a photomicrograph of an etched capillary inserted into a microchannel, in accordance with one embodiment of the present invention.

FIG. 22 is a comparison of peak widths before and after fluorescein peaks passed the interface between the microchannel and capillary of FIG. 21.

### DETAILED DESCRIPTION OF THE PREFERRED EMBODIMENTS

The following description includes the preferred best mode of embodiments of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

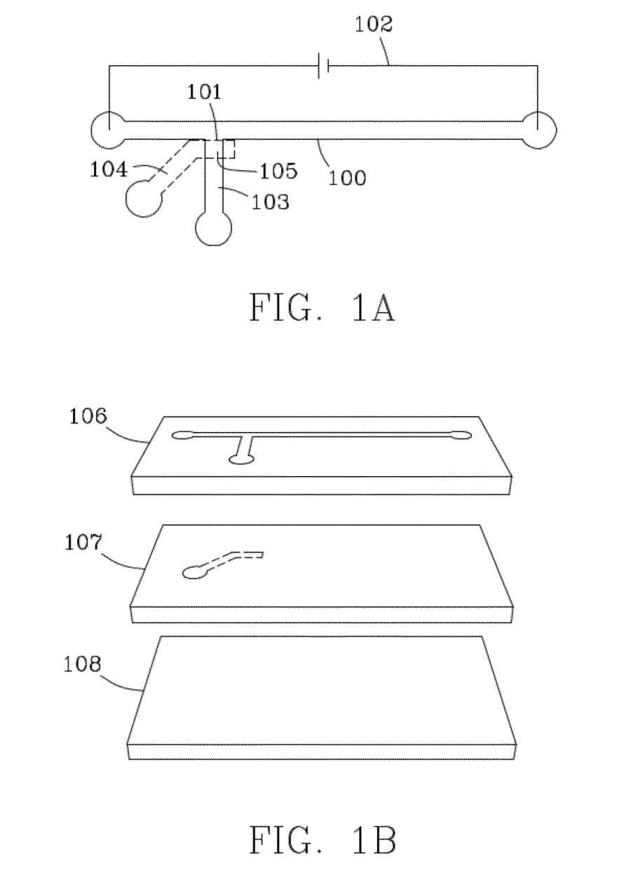

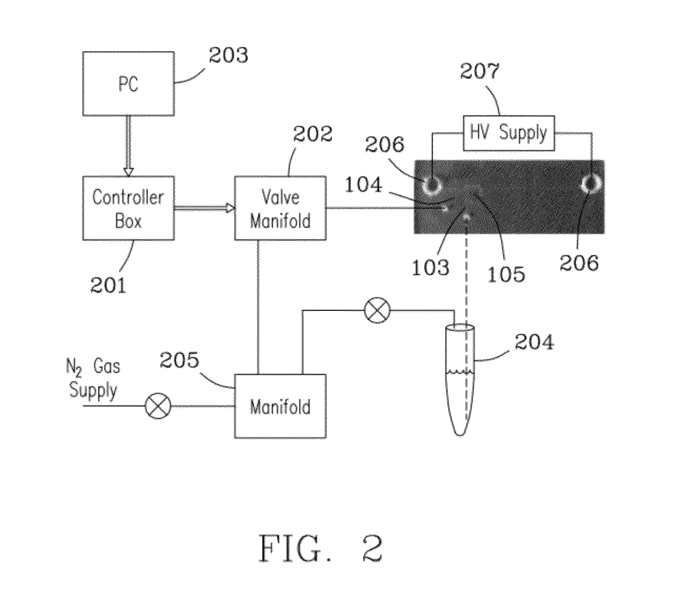

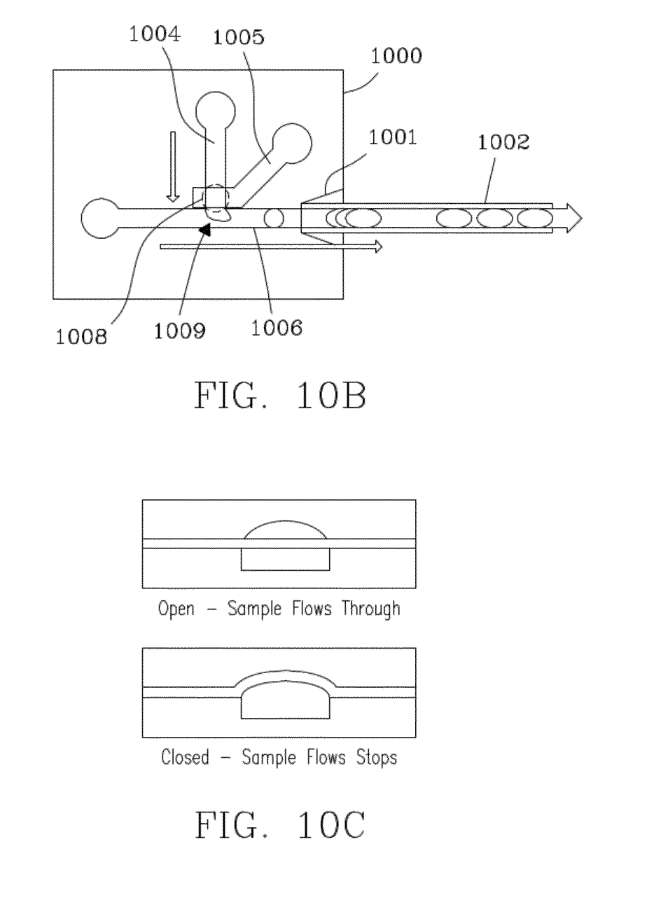

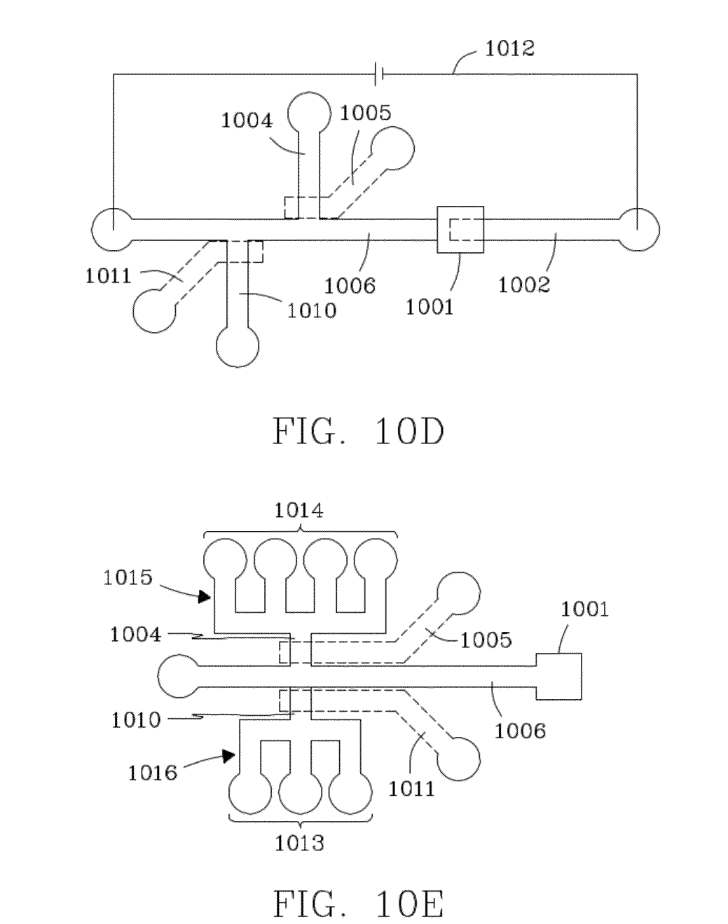

FIGS. 1-9 show a variety of embodiments and aspects of systems in which the separation column is integrated as a CE separation channel into a microchip that also contains the microfluidic injector. FIGS. 10-15 show a variety of embodiments and aspects of systems in which the microfluidic injector is interfaced to a discrete separation column through a loading channel. Referring first to FIG. 1, diagrams of one embodiment of a mechanical valve separating two channels in a microchip CE system are shown. FIG. 1A shows the outline of the microchip structure, which comprises two layers. A flow layer (solid line) contains a CE separation channel 100 and a sample channel 103 with a T-shaped intersection 101. The separation channel has electrodes for applying voltages 102 associated with CE, but the electrodes are not configured for electrokinetic injection. The sample channel does not have electrodes, thereby precluding electrokinetic injection.

The control layer (dashed line) contains a microchannel 104 for valving. An exemplary, but not limiting, width for the channels is 100 μm. Exemplary lengths for the separation and sample channels are 3 cm and 0.5 cm, respectively. The channel 104 on the control layer crosses over the sample injection channel 103 and, therefore, the area at the T-shaped intersection 101 is 100 μm×100 μm and is large enough for a mechanical injector comprising a pneumatic valve 105. The pneumatic valve includes a thin elastomer membrane formed between the two layers. When a pressure is applied in the control channel, the membrane separating the two channels deforms into the flow channel to seal the sample channel (i.e., closed valve). When the pressure is released, the membrane recovers to the original state to open the valve.

Integrated poly(dimethylsiloxane) (PDMS) microchips were fabricated using multilayer soft lithography techniques. First, two kinds of silicon templates were produced using standard photolithographic patterning. The silicon template for the control layer 107 was modified with hexamethyldisilazane (HMDS) using gas phase deposition method in order to assist in releasing the PDMS membrane from the patterned template. A 10:1 weight ratio of PDMS base monomer to curing agent was then mixed, degassed under vacuum, poured onto the patterned wafer for the flow layer 106 to a thickness of 1-2 mm and spin-coated on the surface-modified wafer at 2000 rpm for 30 s to coat the control layer to a thickness of ˜50 μm, and cured in an oven at 75° C. for 2 h. After removing the patterned PDMS with flow channels from the template, a small through-hole was created at the end of sample injection channel by punching the substrate with a manually sharpened syringe needle. Two holes were generated at the ends of separation channel for connections to buffer reservoirs. The flow layer PDMS piece was then cleaned and treated with oxygen plasma for 30 s. Immediately, it was aligned on the top of the control layer PDMS membrane (still on the silicon wafer) and assembled together to enclose the flow channel. After placing in an oven at 75° C. for 2 h to form an irreversible bond, the PDMS block containing flow and control layers was removed from the control layer silicon template, a hole was punched at the end of the control channel, and the substrate was finally bonded to an unpatterned PDMS piece 108 to enclose the control channel using oxygen plasma treatment. An expanded view of the three layers 106, 107, and 108 composing the assembled channels and valve is illustrated in FIG. 1B.

In the present example, polyE-323 was used to coat the PDMS microchannel surfaces to provide anodic EOF in the same direction as electrophoresis for the negatively charged analytes. PolyE-323 is a cationic polyamine, which can be absorbed on negatively charged surfaces through strong electrostatic interaction. The polymer can support strong and stable anodic electroosmotic flow (EOF). To reduce analyte adsorption onto the modified surface resulting from the electrostatic interaction, all samples were prepared in a buffer solution containing 0.5% HPC. Briefly, the PolyE-323 was synthesized by mixing 17.65 g 1,2-bis(3-aminopropylamino)ethane with 20 g water and 9.3 g epichlorohydrine by strong stirring. Two days later, 100 g water was added and the reaction was allowed to continue for 1 week at room temperature. The polymer solution (5 mL) was then diluted in 25 mL of 0.2 M acetic acid, adjusting the pH to ˜7. The diluted polymer solution was filtered using 0.2 μm syringe filters and stored at 4° C.

During the 2 h following the PDMS microchip assembly with oxygen plasma treatment, the diluted polyE-323 solution was pumped into the separation channel through the sample introduction hole for 10 min, and then the solution was left in the channel for 30 min. The channel was then flushed with 10 mM ammonium acetate (pH 7) for 10 min to remove excess polymer. Finally, the microchip was filled with a run buffer (10 mM carbonate buffer, pH 9.3) for CE separation.

FIG. 2 shows a diagram depicting a microchip CE system using pressure injection with the pneumatic valve described above. The valve control sub-system comprises a valve manifold 202 and a controller box 201 controlling the valve manifold. The valve manifold was connected to a second manifold 205 having manually controlled outputs. The second manifold was connected with a regulated continuous N₂ gas pressure supply. One output of the valve manifold was connected to the on-chip control line 104 with a tube to provide pneumatic operation and control of the valve. The pneumatic valve 105 was operated and controlled automatically through a personal computer (PC) 203. The valve actuation time and frequency were set in the software. The valve control channel in the PDMS device can be filled with either water or air, but water was generally used to avoid introduction of bubbles into the flow channels. The sample was contained in a sealed vial 204 with an air inlet to pressurize the sample and an outlet allowing sample to be transferred into the microchannel through a fused-silica capillary. One end of the capillary was immersed into the liquid sample and the other end was inserted into a ˜2 mm long section of Tygon tubing, which was then inserted into the through-hole of the sample injection channel 103 on the microchip. Before injection, any air bubbles trapped in the transfer line and microchannel were removed. For performing microchip CE separation, a high voltage (typically, 3 kV) was continuously applied along the separation channel 100 using a high-voltage power supply 207 via platinum electrodes 206 placed in the reservoirs. The pneumatic valve was actuated to inject discrete sample plugs into the separation channel for subsequent CE separation.

A laser-induced fluorescence (LIF) system was employed for detection. Briefly, a 488-nm line from an air-cooled Ar ion laser was passed into an inverted optic microscope and the fluorescence was collected using a CCD camera. For imaging experiments, a mercury lamp was used as the light source and the fluorescence was collected with a digital camera.

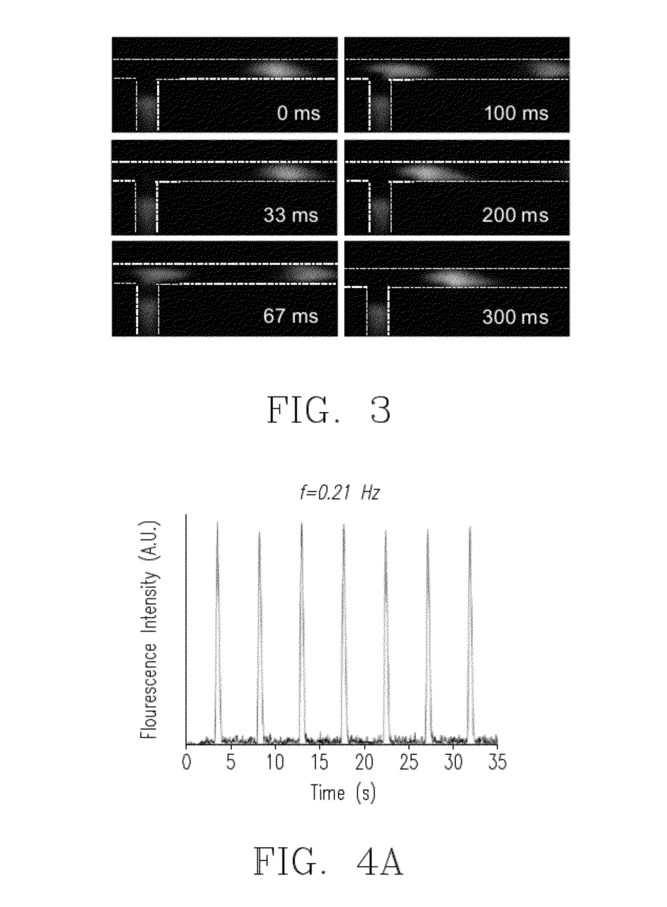

FIG. 3 is a sequence of micrographs depicting one cycle of sample injection controlled by the pneumatic valve embodiment described above. The sample injection pressure was 1.5 psi and the valve actuation time and frequency were 33 ms and 2.2 Hz, respectively. The valve control pressure was 30 psi. The microchannel surface was dynamically coated with PolyE-323 and an electric field of 1000 V/cm was applied along the separation channel. When a negatively charged fluorescein sample plug was injected into the separation channel, the plug migrated downstream to the anode immediately because the electrophoresis of analyte and the electroosmotic flow (EOF) were in the same direction. While the sample plugs in the micrographs exhibit minor blurring due to molecular diffusion effects, there is minimal negative impact on the separation. The injected sample volume shown in FIG. 3 is approximately 270 pL based on the plug shape and the microchannel dimensions.

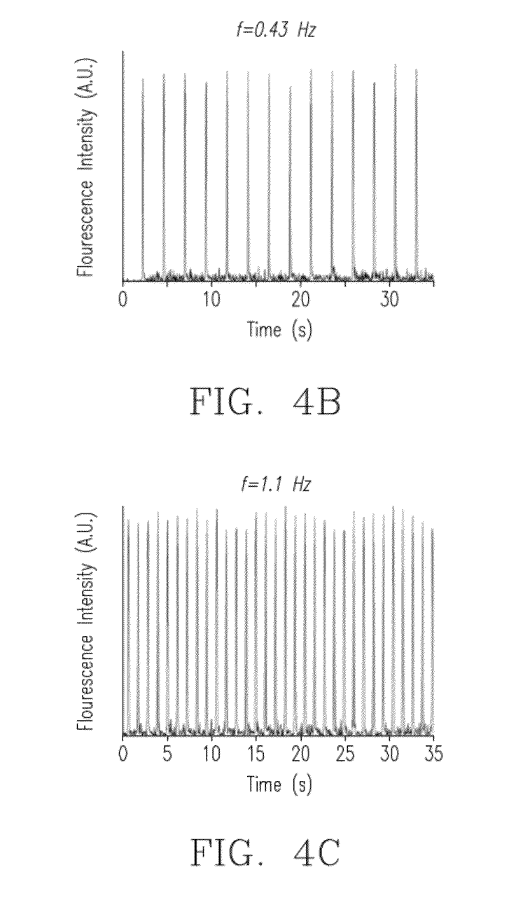

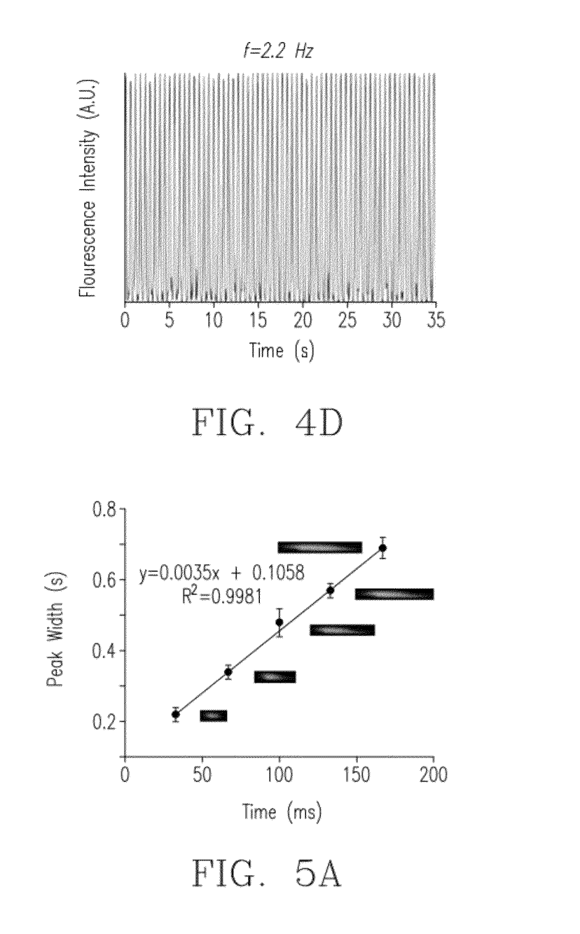

In one embodiment, the sample injection can be operated at different frequencies in the present injection mode. FIG. 4 shows four repeatable injection results at frequencies of 0.21 Hz, 0.43 Hz, 1.1 Hz, and 2.2 Hz, respectively. The fluorescence intensity was recorded close to the T intersection. The relative standard deviations (RSD) of the peak height and width shown in FIG. 4 are listed in Table 1, which indicates good reproducibility has been achieved for repeated injections with RSD less than 3.6%. In all tests, the valve actuation time was the same (33 ms). In FIG. 4A, broader peaks were obtained as the valve control and sample injection pressures were set at 20 psi and 2 psi, respectively, and the injected sample volume was approximately 500 pL. In FIGS. 4B and 4C, the valve control and sample injection pressures were 30 psi and 1 psi, respectively. In FIG. 4D, the valve control and sample injection pressures were set at 30 psi and 1.5 psi, respectively.

TABLE 1
Relative standard deviation (RSD) of the
peak height and width shown in FIG. 4.

| | A | B | C | D |
|---|---|---|---|---|
| RSD of peak height | 1.8% | 2.9% | 3.4% | 1.8% |
| RSD of peak width | 3.4% | 3.6% | 3.3% | 3.6% |

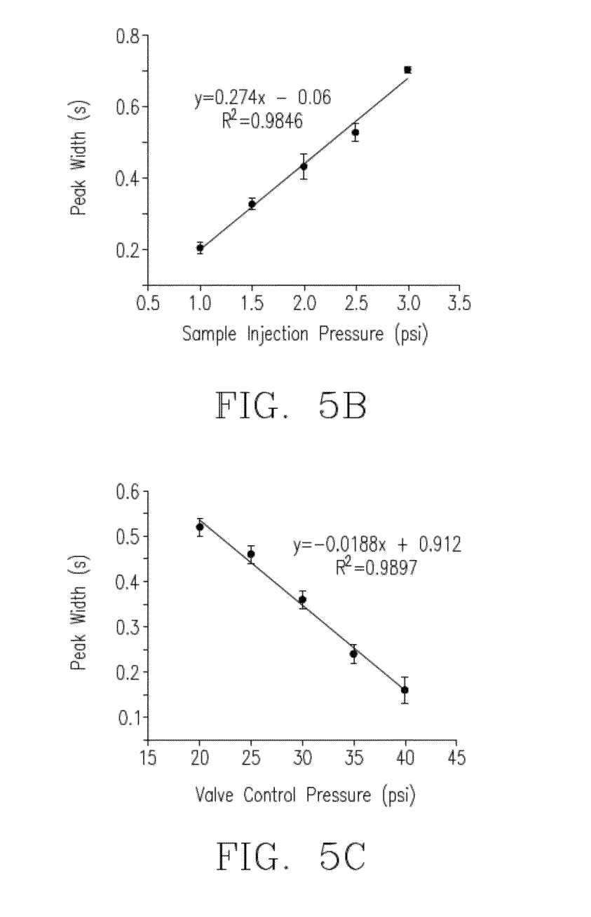

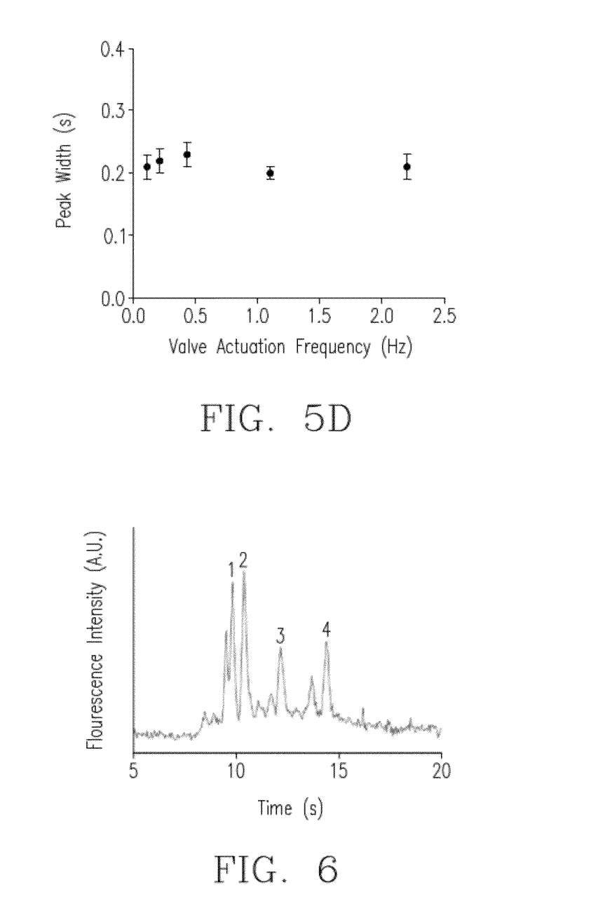

The pressure-injected sample volume can depend on several factors, including the mechanical injector open time, sample injection pressure, and the backpressure present in the separation channel. The mechanical injector open time is determined by the actuation time, the valve control pressure, and the mechanical properties of the injector (e.g., the PDMS membrane in the pneumatic valve described previously). FIG. 5 depicts the relationships between those parameters and the peak width of injected fluorescein samples. Here, the peak width was recorded at approximately 400 μm downstream of the intersection to represent the original injected sample plug size and minimize the influence of the plug migration in the channel and diffusion. All data shown were collected from the same pneumatic valve device.

FIG. 5A shows that the peak width increases linearly with the valve actuation time, because the valve was opened for a longer period of time allowing more sample to enter into the separation channel. In this experiment, the sample injection pressure was 1 psi and the valve control pressure was 30 psi. The valve actuation frequency was 0.21 Hz. Valve actuation times ranging from 33 ms to 167 ms were investigated. The insets are the pictures of the injected fluorescein sample plugs corresponding to different valve actuation times. Based on the length of the sample plugs and the dimension of the channel, the injected sample volumes were estimated from less than 200 pL to approximately 1 nL. Longer actuation time (>200 ms) was not tested because the injected sample plug would be too long to achieve good separation performance. But it is feasible to change the microchannel dimension, by for example, increasing the separation channel depth, to achieve desirable injected sample volume without increasing plug length.

Similarly, the peak width increases with the sample injection pressure (FIG. 5B). As the injection pressure increased, more samples were pressurized into the separation channel when opening the valve because the sample flow rate increased. Here, the valve actuation time (33 ms) and frequency (0.21 Hz) were set constant, and the valve control pressure was 30 psi. Only low injection pressures (1-3 psi) were investigated. When higher injection pressure was applied, the pulsed hydrodynamic flow induced in the separation channel and the longer injected sample plug would destroy the separation. Furthermore, the higher injection pressure increased the back pressure present in the sample channel, increasing the resistance to closing the valve. For example, the fitting line based on the first four points in FIG. 5B shows a linear relationship (R²=0.997). But the fifth point (3 psi) slightly deviates to the upside of the fitting line, which indicates that valve open time is much longer under this pressure.

FIG. 5C shows that the peak width linearly decreases with increase in the valve control pressure. During this investigation, the valve actuation time (33 ms) and frequency (0.21 Hz) and the sample injection pressure (1.5 psi) were kept constant. Valve control pressure was tested from 20 psi to 40 psi. When the pressure was lower, the response of the PDMS membrane to the pressure was slow because of its flexibility. Therefore, it took a longer time to close the valve. This behavior resulted in actual valve open times that were much longer. If the pressure was too low (<20 psi), sample leakage occurred or the injected sample plug was too long, because the valve was not completely closed after actuation. When applying relatively higher control pressures, the PDMS membrane can stick on the channel surface and can take additional time to relax, and then open the valve. On the other hand, the PDMS membrane responds quickly to the pressure to close the valve. Thus, the actual time for the valve to reach the open state can still be shorter. If the pressure was too high, the PDMS membrane can stick to the channel surface too tightly and can take a very long time to open the valve or the valve may not even open during the valve actuation period. In some instances, pressures greater than 40 psi were too high.

FIG. 5D shows that the injected sample plug size is independent of the valve actuation frequency. In these series of tests, the sample injection pressure was 1 psi, the valve actuation time was 33 ms, and the valve control pressure was 30 psi. Because both the sample and the run buffer were diluted aqueous solutions, the variance of the backpressure present in the separation channel was negligible. The injected sample plug size varied little at different valve actuation frequencies.

FIG. 6 shows a CE separation of four FITC-labeled amino acids using embodiments of the present invention. The sample concentration of each amino acid was 250 nM. The valve actuation time and frequency were set as 67 ms and ˜0.1 Hz. The sample injection and valve control pressures were 3 psi and 40 psi, respectively. When the valve was actuated, the data acquisition system was activated to record the fluorescence intensity at the end of the separation channel. The analyte migration distance was measured as approximately 2.4 cm. Only the first cycle of separation was shown in FIG. 6. Four major peaks were completely resolved in 15 s, and some minor peaks showed up due to the impurities present in the sample solution. The theoretical plate numbers of each major peak are calculated and listed in Table 2. The efficiency of the separation is higher than 9.2×10³ plates for ˜2.4 cm long microchannel.

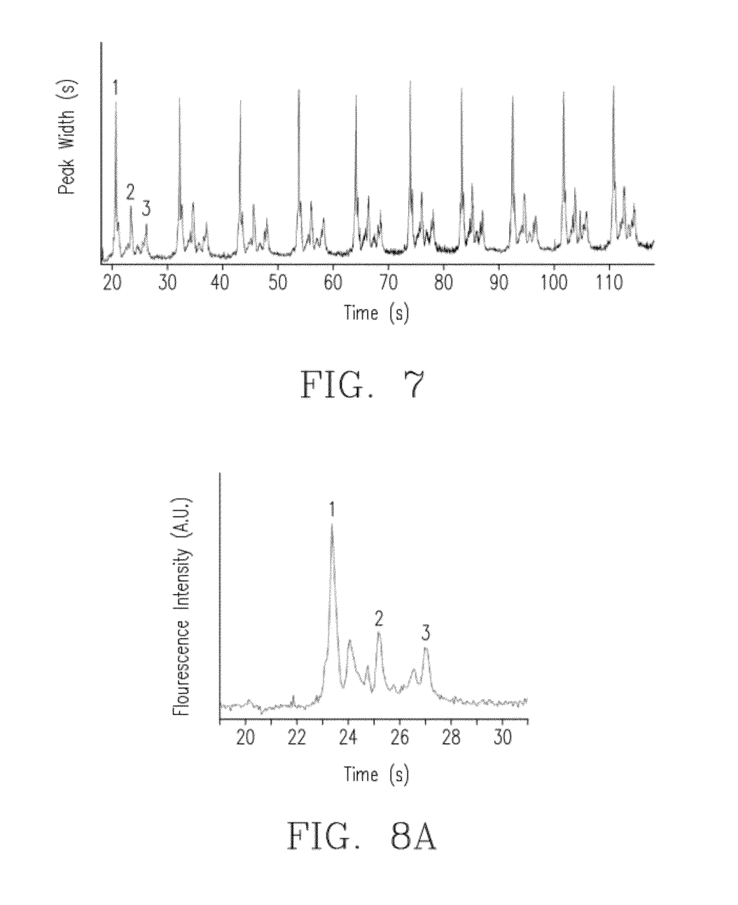

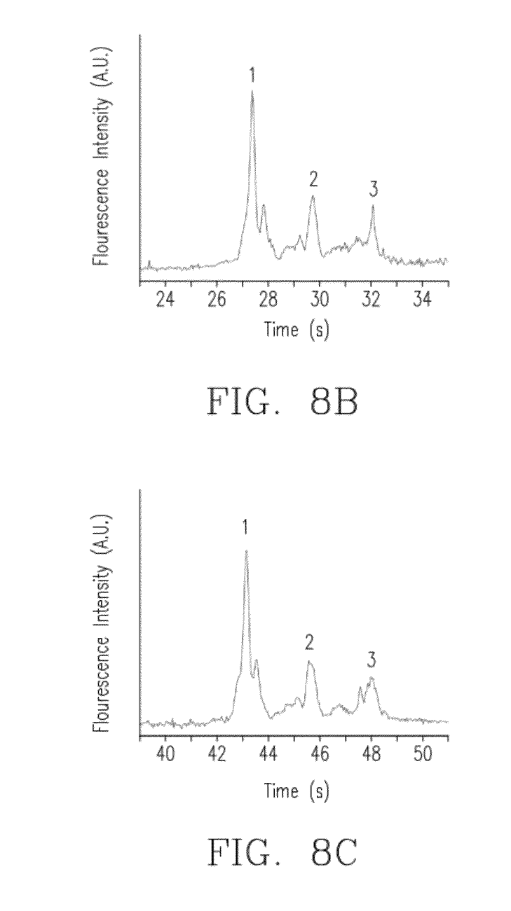

TABLE 2
Theoretical plate numbers of each peak shown in FIGS. 6, 7 and 8.

| | 1 | 2 | 3 | 4 |
|---|---|---|---|---|
| FIG. 6 | 1.3 × 10⁴ | 9.6 × 10³ | 9.2 × 10³ | 1.3 × 10⁴ |
| FIG. 7 | (8.8 ± 0.5) × 10³ | (7.5 ± 0.4) × 10³ | (8.5 ± 1.0) × 10³ | |
| FIG. 8A | 7.4 × 10³ | 1.0 × 10⁴ | 1.3 × 10⁴ | |
| FIG. 8B | 7.7 × 10³ | 8.3 × 10³ | 1.6 × 10⁴ | |
| FIG. 8C | 9.0 × 10³ | 7.0 × 10³ | 7.6 × 10³ | |

FIG. 7 shows a repeated CE separation of three FITC-labeled amino acids. Although only 100-second period of separation (10 runs) is shown, the data was recorded after running the microchip continuously for ˜2 h, corresponding to more than 700 runs. The average separation efficiency for each peak is listed in Table 2. Compared with the separation shown in FIG. 6, the efficiencies obtained in FIG. 7 decreased slightly due to some degradation of the PolyE-323 dynamic coating during the preceding hours of operation. However, the efficiency was higher than 2.9×10⁵ plates/m. It should be pointed out that the peak positions at time scale were not the real peak migration times. The migration times of each peak can be estimated based on the intervals between injections and the first valve actuation time.

FIG. 8 shows portions of FIG. 7 in greater detail. FIGS. 8A and 8B show the same separations performed earlier. Based on the recording time, if the separation shown in FIG. 8A is defined as the first one, the separation in FIG. 8B is approximately the 40^{th} run, and the separation in FIG. 8C is about the 100^{th} run. It should be noted that all three separations are randomly selected to evaluate the pressure injection and microchip separation performance. All peak efficiencies are listed in Table 2. Apparently, the separation is reproducible although the separation becomes slightly worse with increase in the operation time, which is a normal phenomenon because of the dynamically coated surface.

One advantage of pressure-based injection method is a lack of injection bias, which can be evaluated based on the separations shown in FIGS. 7 and 8. We calculated the peak area ratios based on the first peak displayed in each cycle of separation (Table 3). For each peak, the values only fluctuate slightly but appear stable, which indicates that no sample bias is observed in the pressure injection. On the contrary, the values changed approximately 2 times in 20 runs for electrokinetic injection method reported previously.

TABLE 3
Evaluation of the peak area ratios shown in FIGS. 7 and 8.

| peak area ratio | FIG. 7 | FIG. 8A | FIG. 8B | FIG. 8C |
|---|---|---|---|---|
| S2/S1 | 44 ± 3% | 42% | 46% | 44% |
| S3/S1 | 34 ± 3% | 33% | 34% | 37% |

* S1, S2 and S3 represent the peak areas of 1^{st}, 2^{nd} and 3^{rd} peak, respectively, indicated in the Figures.

The fast, reproducible sample injections described above provide for multiplexed CE, in which separations from multiple injections overlap in the separation channel and are subsequently analyzed in comparison and in combination. The multiplexed CE separation can provide an increase in signal-to-noise ratio and a much higher duty cycle compared with discrete CE separations. In some embodiments, multiplexed CE is coupled with LC separations for two dimensions of orthogonal liquid phase separations, and for providing a much greater peak capacity without significant increase in the analysis time. Generally, LC-CE has not been practical using electrokinetic injection, as the low sampling rate and the long delay time required between injections has led to almost all of the sample from the LC column being wasted. The combination of the fast injections and the multiplexed CE can utilize at least 50% of the LC eluent for high-sensitivity, high-peak capacity analyses.

In a preferred embodiment, LC is coupled to fast, multiplexed microchip CE separations followed by high-performance electrospray ionization-mass spectrometry (ESI-MS). Accordingly, a LC column is connected to the sample channel, which provides a plurality of sample injections to the separation channel through a sample injector. The sample injector can include the pneumatic valve describe elsewhere herein or another mechanical valve providing fast, reproducible sample injections without the use of electrokinetic techniques. The separation channel terminates in one or more ESI emitters directed at a mass spectrometer. This configuration can provide at least a 5-fold increase in proteome coverage for complex samples relative to a comparable LC-MS platform alone.

The pressure differential between the sample channel and the separation channel is such that upon briefly opening the mechanical valve, analyte is rapidly introduced for separation. A potential is continuously applied in the separation channel enabling automatic separation of the sample injection. Preferably, the plurality of rapid injections occurs in a pseudorandom sequence resulting in multiple overlapping separations, which can be deconvoluted to reconstruct a spectrum. Deconvolution can be achieved according to a modified Hadamard transform. The achievable gain in signal-to-noise ratio relative to simple signal averaging can be proportional to the square root of the number of injections.

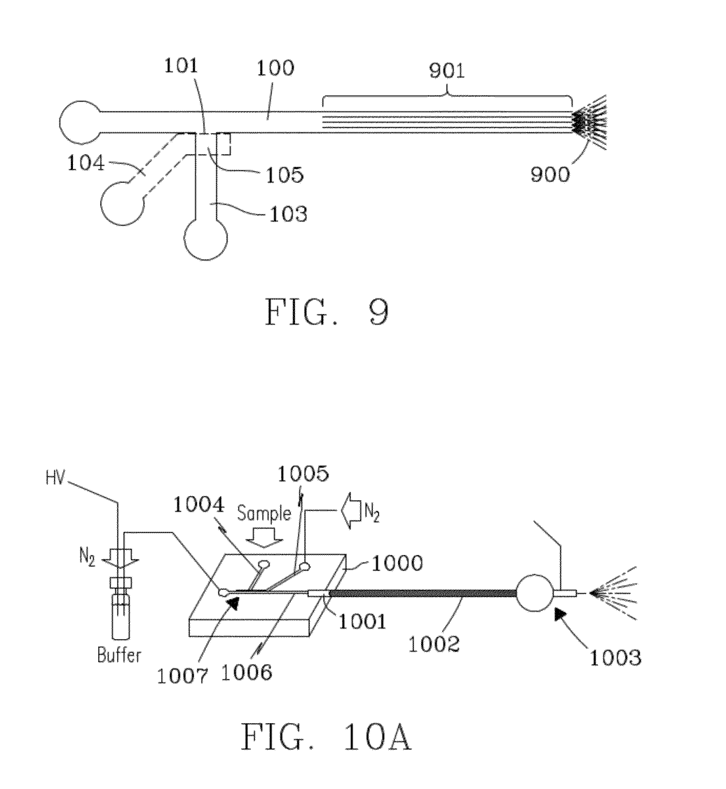

As mentioned elsewhere herein, one challenge in coupling LC and CE separations is the disparity in sample flow rates associated with each technique. LC typically requires higher flow rates by orders of magnitude. Accordingly, referring to FIG. 9, a preferred embodiment of the present invention includes a single pneumatic injector that spans multiple CE channels 901 within the separation channel 100. When coupled with LC, the eluent from the LC column can be provided as a relatively large sample injection by the sample injector and can be distributed among a plurality of CE channels. In one instance, twenty or more CE channels can exist within the separation channel. Generally, the injection volume can be increased in direct proportion with the number of CE channels, enabling high resolution separations while processing sample volumes compatible with typical nanoLC flow rates (e.g., 100-500 nL/min).

Preferably, each CE channel will terminate with an electrospray 900 at its own ESI emitter. The array of emitters can provide an order of magnitude sensitivity improvement relative to a single emitter analysis. The enhanced sensitivity, in combination with the greater than ten-fold gain in peak capacity relative to the equivalent LC separation alone can lead to significantly improved dynamic range, more quantitative ionization, and greatly increased sample identifications.

In some embodiments, rather than utilizing a separation channel that is integrated into the microchip containing the microfluidic injector, a discrete separation column is interfaced to the microfluidic injector through a port configured for connecting the separation column to a loading channel. Referring to FIG. 10A, a schematic illustration depicts one embodiment of a microfluidic injector 1007 fabricated on a PDMS microchip 1000 and interfaced to a discrete separation column 1002 through a loading channel 1006 having a port 1001 at the terminal end. The PDMS microchip was created from three patterned templates: a control layer, a flow layer and a cover plate, using multilayer soft lithography similar to embodiments described elsewhere herein. The control layer channel 1005 was 25 μm tall and 100 μm wide and was rectangular in cross-section. The flow layer channels, which include the sample channel 1004 and the loading channel 1006, were ˜10 μm tall, 100 μm wide, and were rounded in cross-section to enable complete channel closure using the on-chip pneumatic valve. To accommodate in-line insertion of the separation column 1002, the loading channel 1006 terminated at a port 1001 that had a rectangular cross-section, with a height and width that accommodates the separation column 1002. The embodiment in FIG. 10A is depicted with an optional ESI emitter 1003 at the terminal end of the separation column. In one example, using a fused-silica capillary tube as the separation column, the port had a height of 160 μm and a width of 310 μm. A cover plate contained a channel of rectangular cross-section that was 310 μm wide channel and was 110 μm thick.

Referring to FIGS. 10B and 10C, detailed illustrations depict the T-shaped intersection of the sample channel 1004 and the loading channel 1006 as well as the overlap of the valving channel 1005 and the sample channel. The valving channel 1005 in the control layer crosses over the sample channel 1004 in the flow layer at or near the T-shaped intersection 1009. A mechanical valve represented at location 1008, and shown in FIG. 10C, comprises a deformable membrane between the control layer and the flow layer and separates the valving channel and the sample channel. Referring to FIG. 10C, the membrane has a closed position to obstruct flow in the sample channel, and an open position to permit flow in the sample channel based on a first and second pressure, respectively, in the valving channel.

Referring to FIG. 10D, an illustration depicts a configuration having two sample channels. The first sample channel 1004 and valving channel 1005 intersect the loading channel 1006 at a different position than the second sample channel 1010 and valving channel 1011. In other embodiments, the two sample channels can intersect the loading channel at the same position along the length of the loading channel. Furthermore, additional sample channels can intersect the loading channel at different positions. As illustrated, the two sample channels interface the loading channel in a single plane. However, in some embodiments, sample channels can be fabricated in different planes. Developments in 3-D printing and other manufacturing technologies are well known for such fabrication capabilities. A separation column 1002 interfaces with the loading channel at a port 1001. CE electrodes and applied voltage 1012 are configured for separation along the continuous length of the loading channel and separation column.

Referring to FIG. 10E, an illustration depicts a configuration having two sample channels, each having a plurality of sample sources. A first sample channel 1004 is fed by four sample sources 1014 via a manifold 1015. A second sample channel 1010 is fed by three sample sources 1013 via a manifold 1016. Valves (not illustrated) and other fluid flow devices can be used to select and/or control the sample sources providing sample to a sample channel.

The variety of sample injection possibilities enabled by embodiments having multiple sample channels and/or multiple sample sources per sample channel enables a high degree of analytical flexibility. For example, on-column sample derivatization can enable or enhance chemical analyses. To perform on-column sample derivatization, one sample channel contains an analyte or a mixture of analytes (Sample Channel A). Another sample channel contains the derivatization reagent or mixture of reagents (Sample Channel B). Alternatively, Sample Channel A may contain derivatization reagent(s) and Sample Channel B may contain analyte(s). If the two sample channels are located in close proximity to one another, the valves separating the analyte(s) (Valve a) and derivatization reagent(s) (Valve b) may be opened simultaneously such that a mixture of analyte(s) and derivatization reagent(s) is formed in the sample loading channel. Alternatively, if A and B are not in close proximity, the timing for opening Valves a and b may be staggered such that Valve a is opened first, sample from Sample Channel A moves to the proximity of Sample Channel B, at which time Valve b is opened to achieve mixing of A and B.

Multistep sample derivatization procedures may also be achieved beyond simply combining sample from Sample Channels A and B. For example, A and B may be located in close proximity to one another and opened simultaneously to initiate the first step of a derivatization reaction. A third sample channel (C) and its corresponding valve (c) may be located downstream of A and B. The distance from Channels A and B to Channel C, and the velocity of the mixture of A and B as it travels to C will determine the amount of time that A and B have to react prior to the introduction of C by opening Valve c. By adding additional sample channels D, E, etc., each with corresponding valves d, e, etc., on-column derivatization reactions having more individual mixing steps may be accomplished. One example of a multistep derivatization reaction would be one in which A contains analyte(s), B contains an acid or a base that is used to alter the charge state of the analytes in A, and C contains the derivatization reagent that only binds to A in the charge state achieved by prior combination with B.

Examples of sample derivatization procedures that may be employed to enable or enhance chemical analyses include, but are not limited to, (1) adding a radiolabel for detection of analytes based on the radioactive decay of the label; (2) adding a fluorescent molecule to an analyte that does not fluoresce natively for fluorescence detection; (3) attaching a hydrophobic moiety to an analyte that in its native state exhibits low ionization efficiency when detected using electrospray ionization mass spectrometry; (4) attaching a singly or multiply charged moiety to alter the charge state of the analyte. (4) may be used to impart charge to a mixture of natively uncharged analytes that cannot otherwise be separated by capillary electrophoresis. There are numerous other sample derivatization procedures beyond the four examples provided here that can be used to enable or enhance chemical analyses.

PDMS for fabrication of the microchip was prepared by thoroughly mixing a silicone elastomer (Sylgard® 184) base and curing agent at a 10:1 ratio. The PDMS was poured onto the control layer template and spin-coated at 2000 rpm for 30 s. PDMS was also poured over the flow layer and cover plate templates to a thickness of 3-4 mm and degassed under vacuum. All substrates were cured at 70° C. for 2 h. The flow layer substrate was then removed from its template and holes were formed using a 20 gauge catheter punch. Debris was removed from the substrate by applying compressed nitrogen followed by tape to both sides. The surfaces of the flow layer and control layer substrates were activated in an oxygen plasma system at 50 W power and 200 mTorr pressure for 30 s. Following activation, the flow layer substrate was aligned at the sample introduction intersection and brought into contact with the control layer with the aid of a digital microscope. The irreversibly bonded assembly was placed in an oven at 70° C. for 1 h to improve bond strength and then the bonded flow and control substrates were cut and removed from the control layer template. It was necessary to remove the portion of the membrane that spanned the loading channel. This was accomplished by grasping the suspended membrane with a pair of fine-tipped tweezers and carefully pulling in such a way that the membrane tore along the loading channel walls. A hole was punched through both substrates as described above to provide access to the pneumatic valve, and the assembly was again cleaned using a combination of compressed nitrogen and tape. The microchip injector was completed by aligning and bonding the flow and control layers to the cover plate as described elsewhere herein.

According to the example mentioned above, fused silica capillaries having an o.d. of 140 μm and an i.d. of 30 μm were passivated with HPC to suppress electroosmotic flow. The coating was prepared by first flushing a ˜2.5 m long capillary with 1 mL of 1 M HCL solution by applying 15 psi N₂ back pressure to the solution reservoir followed by flushing the capillary with 200 μL 5% HPC in water using 20 psi N₂ back pressure. The capillary was then flushed with deionized water to remove excessive hydroxypropyl cellulose. The treated capillary was subsequently cut into 10 equal lengths and ˜3 cm at the end of each length was chemically etched in 49% HF to render it porous for electrical contact as described previously. The etching of all 10 capillaries took place in a single batch using an approach adapted from previous work. Once etched, the distal end (inlet) of the capillary was inserted into a ˜5 cm length of 360-μm-o.d., 150-μm-i.d. capillary and sealed in place with epoxy. This same end was cut a few mm from the inlet using a dicing saw (SYJ-400, MTI Corp., Richmond, Calif.) to provide a clean interface at the loading channel-capillary interface. An assembly consisting of a PEEK tee and an inserted metal tube (0.04″ i.d., 1/16″ o.d)²⁷ was then slid onto the capillary from the inlet end to form an optional, sheathless ESI interface. The emitter end of the etched capillary protruded 1-2 mm from the metal tube. The capillary inlet end was then inserted under a microscope into the 3-mm-long port that to connect the capillary to the loading channel on the microchip and a small amount of PDMS was applied at the loading channel-capillary interface. The PDMS was cured by placing the assembly in an oven at 110° C. for 20 min.

With the mechanical valve closed, a few microliters of sample was loaded into a pipette tip, which was then press-fitted into the sample port on the chip. To pressurize the sample, a length of tubing connected to a digital pressure controller was inserted into a round PDMS plug, which was in turn pressed into the wide end of the pipette tip to form an airtight seal. The sample was pressurized to 5 psi to dead-end fill the sample against the closed valve and then the sample pressure was adjusted as needed for operation. The CE run buffer was loaded into a sample vial sealed afterward to allow a N₂ back pressure to be applied to the buffer liquid as shown in FIG. 10A. High voltage for CE operation was applied to a platinum wire inserted into the buffer solution using a Glassman High Voltage power supply (High Bridge, N.J.). A transfer fused silica capillary (360 μm o.d., 50 μm i.d.) with one end inserted into the buffer solution and the other end press-fitted into the microfluidic chip using a short length of Tygon tubing as a sheath was used to provide the CE run buffer to the device. The N₂ back pressure controlling the flow through the CE capillary, referred to as the eluting pressure, was regulated using a second digital pressure controller. A second voltage of ˜2 kV was applied to the metal tube at the capillary outlet through a Bertan power supply (Hauppauge, N.Y.) to provide for stable electrospray operation.

All CE-nanoESI-MS analyses were performed using a triple quadruple mass spectrometer. The inlet capillary of the mass spectrometer was maintained at 200° C. Mass spectra were acquired in full scan mode covering an m/z range from 300 to 1000 at an acquisition rate of 2 Hz. Leucine encephalin, kemptide, angiotensin II, methanol, acetic acid, hydrofluoric acid, ammonium acetate and hydroxypropyl cellulose (HPC, average MW ˜100,000) were utilized for demonstrating the injection, CE separation, and mass spectrometry analysis. Peptide stock solutions were prepared individually in water at a concentration of 1 mg/mL. A 10 μM mixture of the three peptides was then prepared by dilution from the stock solutions into the run buffer. The run buffer was 9:1 20 mM aqueous ammonium acetate: methanol, adjusted to pH 4 with acetic acid. Colored dye was used for visualizing pressure-driven injection and transfer of the sample plug to the capillary.

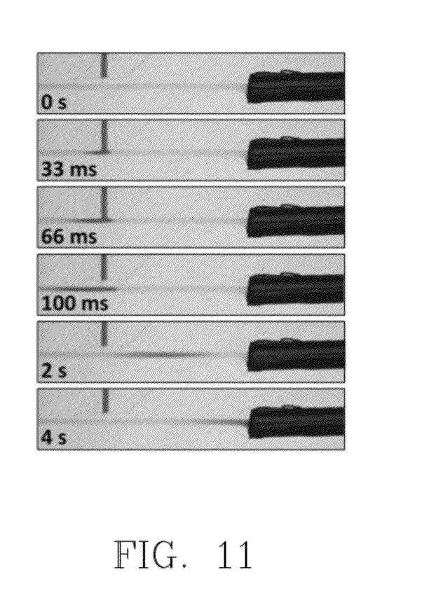

A pressure-driven injection sequence is shown in FIG. 11 using an aqueous dye in place of the sample and in the absence of an electric field. The eluting and sample pressures were 2.0 and 2.5 psi, respectively, and the valve opening time was 65 ms. The interfaced capillary had a 30 μm i.d. and was 75 mm long. To estimate the volume of this and other sample plugs, it was necessary to know the cross-sectional area of the rounded microchannel. This was determined by filling the separation channel in both the microchip and capillary with perfluorodecalin, an immiscible oil, injecting colored dye from the sample channel, and comparing the length of the plug in the microchannel and inside the capillary of known diameter. It was determined that the microchannel had a cross-sectional area of 450 μm², equivalent to a 24-μm-diameter capillary. The injection volume shown in FIG. 11 was approximately 400 pL, a plug size typical of microchip electrophoresis, and the volume could easily be tuned larger or smaller by adjusting the valve opening time and the sample injection pressure. Importantly, the back pressure was such that when an injection took place, the sample traveled mostly upstream, thereby minimizing any pressure shock that could affect an ongoing separation. For the eluting pressures evaluated here, the flow rate was found to range from ˜20 to 100 nL/min. These flow rates are in the nanoflow regime, enabling high ionization efficiency for improved MS detection, when utilized.

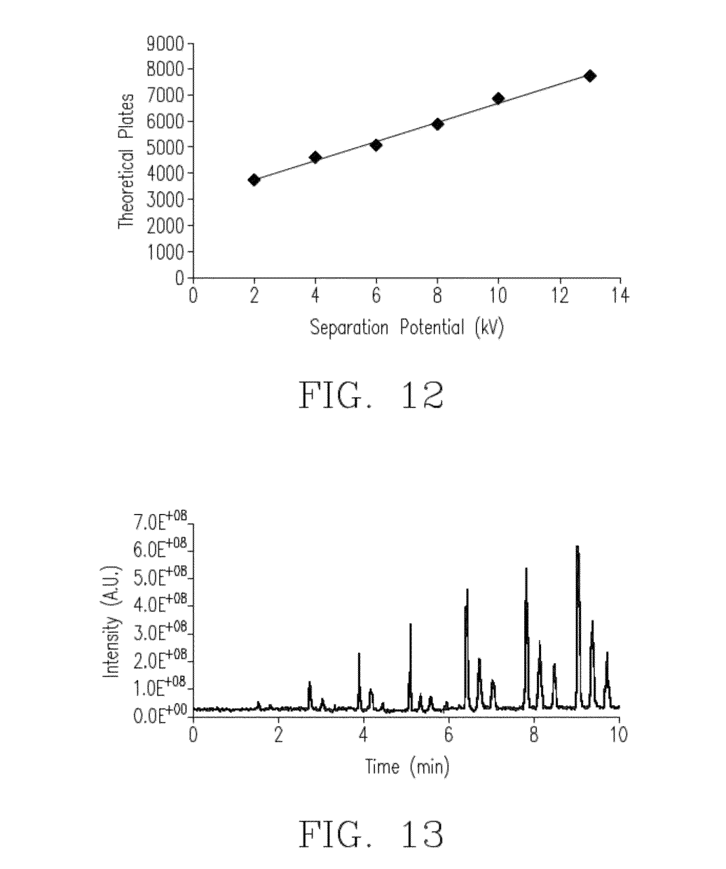

For initial characterization of CE separation, we determined the number of theoretical plates as a function of separation potential. Theoretical plates were calculated using the formula:

$$N = 16 {( \frac{{t}_{r}}{w} )}^{2}$$

where tᵣ is the retention time and w is the baseline peak width. As expected, plate number increases linearly with voltage as shown in FIG. 12, albeit with a y-intercept offset from the origin resulting from the pressure-assisted mode of separation. For the separations represented in FIG. 12, an injection time of 500 ms was used and the injection and elution pressures were both 2 psi. Efforts to further increase the number of theoretical plates by increasing the separation potential resulted in electrical breakdown and bubble formation in the channels, so 13 kV was used for subsequent experiments.

The computer-controlled, pressure-driven injection described herein can enable significant flexibility and tuning of separation conditions and acquisition of those separations in a rapid, automated fashion. As an example, FIG. 13 shows a series of repeated separations of a three-peptide mixture containing kemptide, angiotensin II and leucine encephalin. During this experiment, the valve was opened every 1.25 min to inject the sample, and the valve opening time was varied from 0.1 s to 3 s throughout the series. The trend of increasing peak intensity with injection time is clear. The uninterrupted acquisition of repeated separations under different conditions is straightforward using this approach as the separation voltage is continuously applied during both injection and separation. Only the microfluidic valve state is modulated. In contrast to common injection techniques that send the vast majority of sample to waste to accomplish an efficient injection or require a large sample reservoir, our approach enables a minimum volume (a few microliters in the present example) of sample to be loaded by pipette onto the device and for that entire sample to be used for repeated injections. This can be useful for multiplexed separations to improve the signal-to-noise ratio and for the analysis of precious biological samples.

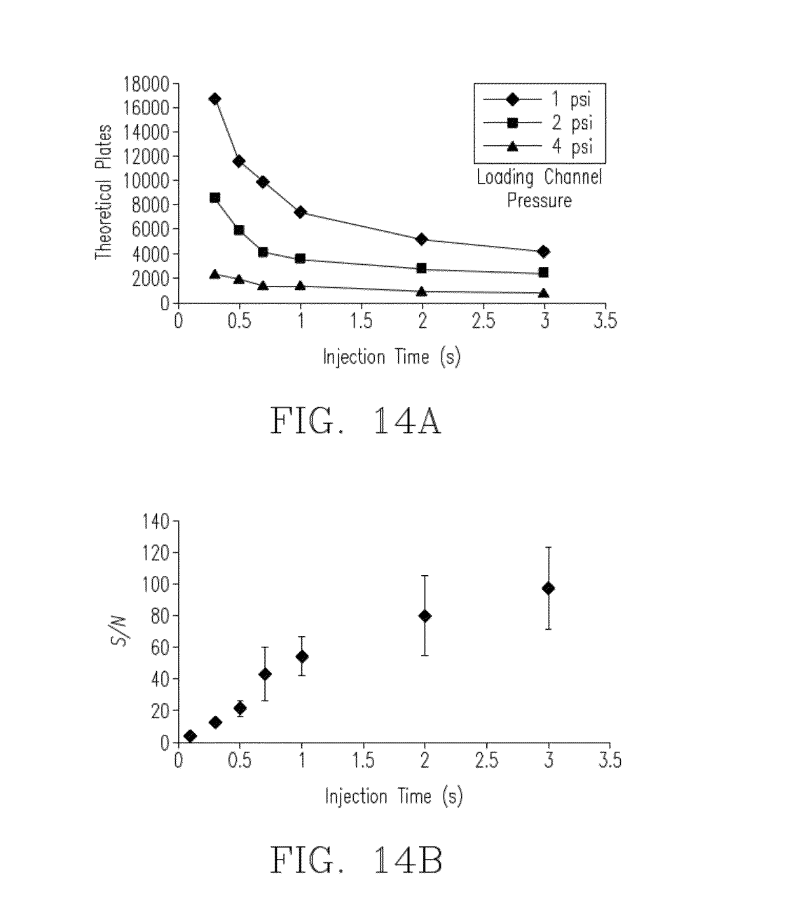

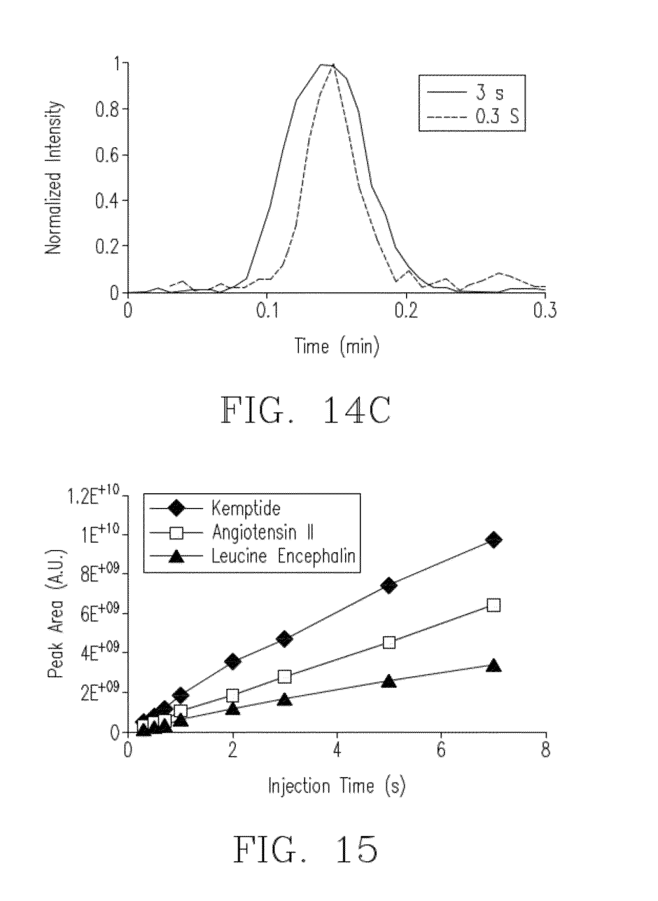

The tradeoff between separation efficiency and S/N as the injection volume is varied is shown in FIG. 14. In FIG. 14A, the number of theoretical plates as a function of injection time is shown for three different elution pressures. Values were calculated for the leucine encephalin peak. Higher flow rates resulted in reduced plate counts due to increased Taylor dispersion, and in each case, smaller injection plugs produced narrower detected peaks and thus greater plate counts. The modest separation efficiency achieved here is due to the pressure-assisted mode of operation, as even at the lowest pressure used (1 psi providing a flow rate of ˜20 nL/min), Taylor dispersion degraded separation performance.

While plate count diminished with increasing injection times, S/N showed the opposite trend, increasing with longer injections. FIG. 14B shows the S/N for kemptide for three replicate measurements using 2 psi for both the sample injection and the elution pressure. Noise was calculated from the data points in the range of 0.4 to 0.2 minutes before the apex of each peak. FIG. 14C shows two overlaid kemptide peaks, one acquired from a 0.3 s injection and the other from a 3 s injection. The peak resulting from a 0.3 s injection is clearly narrower than that from the 3 s injection, but the S/N is also substantially reduced as reflected in the baseline adjacent to the peak. This demonstrates the ease with which separation performance can be assessed and optimized over a range of conditions using this approach.

In addition to the ability to perform repeated, waste-free, programmable injections without impacting ongoing separations, another key benefit of the embodiments described herein is that sample injection is pressure based, and expected to avoid quantitative biases inherent in electrokinetic injection strategies of the prior art. We verified this by evaluating the peak area for each of the peptides in the mixture for injection times ranging from 0.3 s to 7 s. The elution and sample injection pressure was 2 psi for all data points. As shown in FIG. 15, the peak area for each analyte increases linearly with injection time and as such, the proportionality between peptides is maintained, even across this range of injection times spanning more than a factor of 20.

In another embodiment of the present invention, a system and method of preconcentrating analytes at a microvalve in a microfluidic device is disclosed.

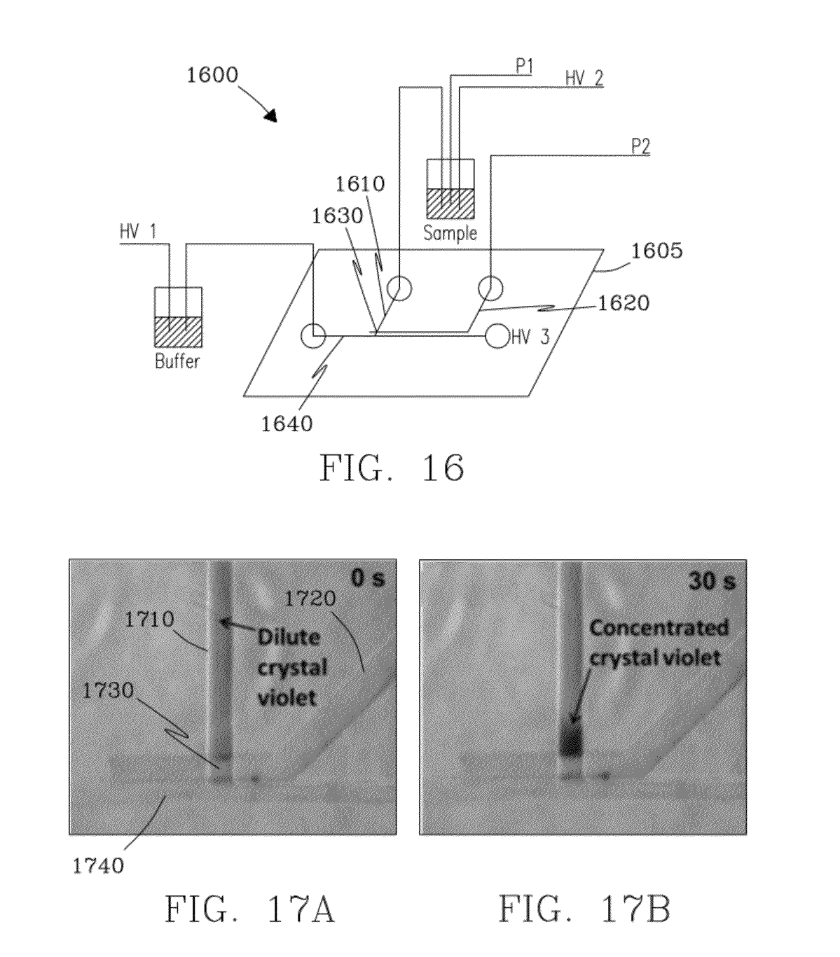

FIG. 16 is a schematic depicting one embodiment of a system 1600 for preconcentrating analytes at a microvalve in a microfluidic chip or device 1605, in accordance with one embodiment of the present invention. A sample solution is loaded into a sample channel 1610 by applying pressure P1. A control channel 1620, which intersects the sample channel 1610, is closed with an applied pressure P2. In this example, a semi-permeable membrane microvalve—or a microvalve with a semi-permeable membrane—is positioned at an intersection 1630 of the control channel 1620 and the sample channel 1610. The sample channel 1610 is coupled to a second channel 1640 downstream of the control and sample channel intersection 1630. The second channel 1640 may be, but is not limited to, a separation channel. In this example, the sample channel intersects the separation channel in a T-junction configuration.

The microfluidic device 1605 contains the sample channel 1610, the control channel 1620, and the separation channel 1640. In one embodiment, the sample channel 1610, the control channel 1620, and the separation channel 1640 are integrated into the microfluidic device 1605.

In one embodiment, the sample channel 1610 is coupled to the sample solution source via a first connector or port. The control channel 1620 is coupled to pressure P2 via a second connector or port. The separation channel 1640 may be coupled to the buffer solution via a third connector or port and to an ESI source via a fourth connector or port.

When the microvalve is closed, the sample solution cannot flow through the sample channel 1610. When the microvalve is open, the sample solution can flow through the sample channel 1610. The sample solution is introduced into the second or separation channel 1640 when the microvalve is open.

In one embodiment, the sample solution is simultaneously preconcentrated in the sample channel 1610—or at the intersection 1630 of the control and sample channels—when an electric potential or voltage is applied at or across the membrane and separated in the separation channel 1640 when the microvalve is closed. In one embodiment, the applied voltage at or across the membrane is between 100 and 5000 volts.

Still referring to FIG. 16, the system for preconcentrating analytes includes a buffer solution which is introduced into the separation channel 1640 along with the sample solution. A first electric potential HV1 controls the buffer solution. A second electric potential HV2 controls injection of the sample solution. A third electric potential HV3 maintains an electric field gradient in the separation channel 1640.

In one embodiment, the buffer solution is between 1 and 500 millimolar.

In one embodiment, the thickness of the membrane is less than 100 micrometers.

The electric potentials HV1, HV2, and HV3 are adjusted or set such that analytes from the sample solution are driven to and focused at the closed membrane. When the valve is opened, the concentrated analytes are loaded onto the separation 1640 channel for CE separation.

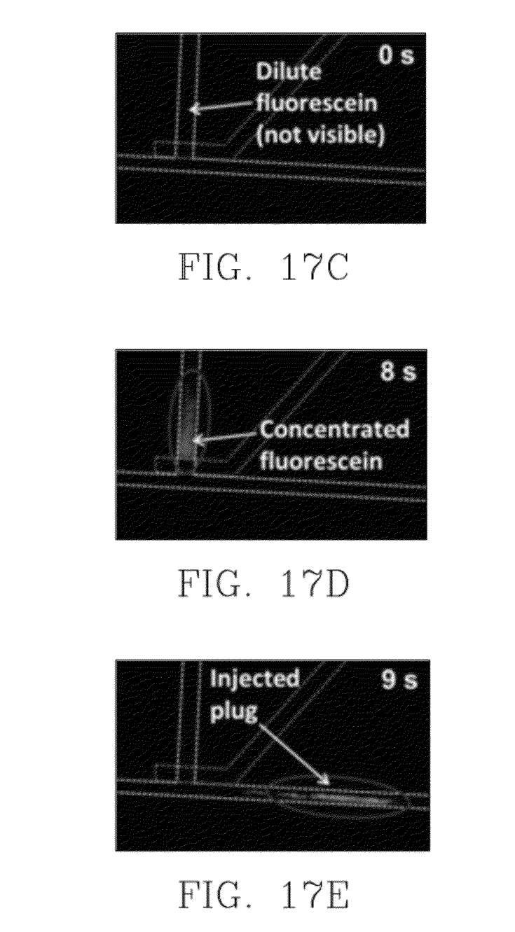

FIGS. 17A-E are images showing the preconcentration of a cationic crystal violet molecule (FIGS. 17A-B) and preconcentration followed by injection of a anionic fluorescein molecule (FIGS. 17C-E), demonstrated in a set-up similar to the system shown in FIG. 16. FIG. 17A shows a sample channel 1710 intersecting a separation channel 1740 in a T-junction configuration. A control channel 1720 crosses the sample channel 1710 at an intersection just upstream of the T-junction intersection. The T-junction channel containing a microvalve with a semi-permeable membrane 1730—or semi-permeable membrane microvalve 1730—at the intersection was used for isolating the sample channel 1710 from the separation channel 1740. The isolation enables concentration to take place while a separation is in process. With the microvalve closed, the sample is driven to the membrane 1730 from a sample vial and stacked at the membrane 1730. The concentrated sample is then pressurized into the separation channel 1740 by opening the microvalve 1730.

Crystal violet, a cationic visible dye, and fluorescein, an anionic fluorescent dye, were used to test the ability of preconcentration and injection of cationic and anionic species, respectively. For crystal violet preconcentration and injection, 100 mM acetic acid in 10% (v/v) methanol/water solution was used as the run buffer. For fluorescein preconcentration and injection, 10 mM ammonium acetate in 10% (v/v) methanol/water solution was used as the run buffer. FIGS. 17A-B show the preconcentration of the crystal violet molecule, and FIGS. 17C-E illustrate preconcentration followed by hydrodynamic injection of fluorescein. The enrichment factor of 1 μg/mL sodium fluorescein in 8 s was calculated as ˜70 based on the standard curve generated from the fluorescence measurements of 4 fluorescein concentrations (20, 50, 100, 200 μg/mL). The small molecular weights of fluorescein and crystal violet (≦400 Da.) indicate that the membrane has a low molecular weight cutoff and should be applicable to a wide range of analytes.

The potential applied across the closed membrane enables sufficient current to pass through to provide analyte stacking or concentration, while opening of the valve enables the concentrated analytes to be rapidly injected as a narrow plug onto a flow or separation channel. The method and system for preconcentrating analytes at a semi-permeable membrane microvalve provides the benefit of enrichment while still enabling high resolution separation. In addition, the method and system should enable hybrid liquid chromatography-CE separations, as the eluent from LC can be concentrated and periodically injected for CE separation, with total analyte utilization, providing a platform for bioanalytical separations having unprecedented throughput, peak capacity, and sensitivity.

The Present Invention discloses advances that include: conditions for enhancing the preconcentration of analytes by maintaining low buffer concentrations, and thus low ionic strengths, in the sample solution; surface treatment methods for the preconcentration and separation of negatively charged species; surface treatment methods enabling the preconcentration of positively charged species; and methods and systems of preconcentration that include coupling the microfluidic device for preconcentration of analytes with capillary-based separations.

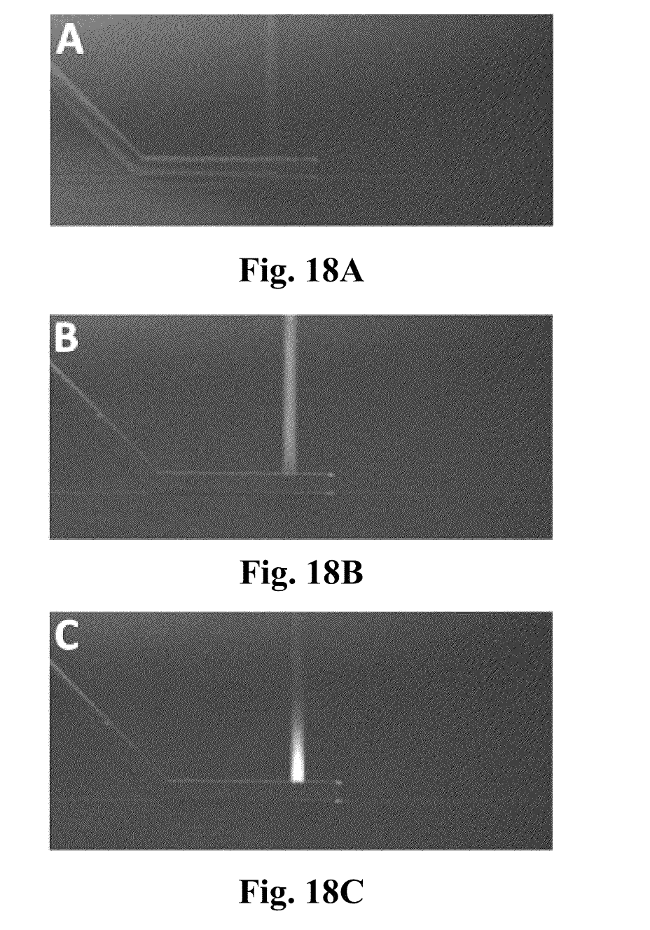

FIGS. 18A-C are images showing the preconcentration using different concentrations of the sample solution, with the sample concentration being 1 μM FITC-labeled leucine enkephalin in 8 mM sodium carbonate with 0.5% HPC in FIG. 18A, 1 μM FITC-labeled leucine enkephalin in 2 mM sodium carbonate with 0.5% HPC in FIG. 18B, and 1 μM FITC-labeled leucine enkephalin in 0.5 mM sodium carbonate with 0.5% HPC in FIG. 18C). The buffer solution in the separation channel was 10 mM sodium carbonate with 0.5% HPC. The voltage applied on the waste reservoir was 2 kV. The buffer and sample reservoirs were grounded. The pressure applied on the control channel for microvalve closure was 40 psi and the pressure applied on the sample channel for injection was 0.5 psi.

As shown in FIGS. 18A-C, lowering the concentrations of the sample solution—from 8 mM in FIG. 18A to 0.5 mM in FIG. 18C—enabled enhanced preconcentration of the sample solution. preconcentration factors in excess of 1000 have been achieved.

Another factor affecting performance includes the voltage applied across the microvalve. Higher voltages applied across the microvalve lead to increased currents and therefore are expected to increase rates of preconcentration. The force applied to the microvalve is also expected to affect performance, as greater forces lead to decreased current passing through the closed microvalve and therefore a likely decrease in the rate of concentration.

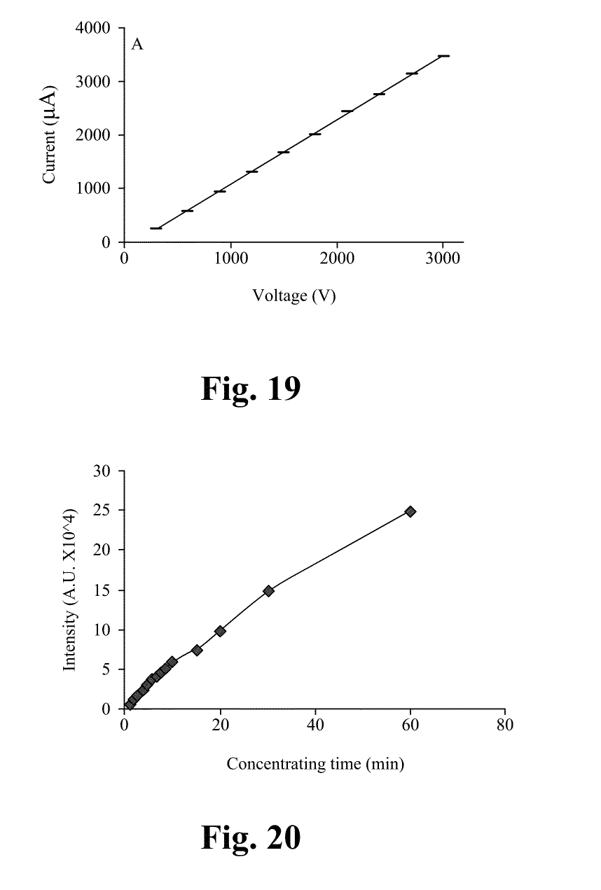

In some embodiments, the methods of the present invention include improved surface treatments for preconcentrating and separating negatively charged species or anionic analytes. For preconcentration of negatively charged ions, the microfluidic device is baked at a temperature range of approximately 100 to 150° C., which provides much more consistent electrical properties. That is, the closed microvalves behave like resistors and provide an ohmic response to changes in voltage, as shown in the plot of current vs. voltage of FIG. 19 for closed microvalves on three different devices. Further, the weak negatively charged surface on the native PDMS surfaces provides for appropriate conditions for preconcentration. In one particular embodiment, the device is baked in an oven for several hours at approximately 120° C.

It is also advantageous to treat the surface of the separation channel to minimize interactions of the analytes with microchannel walls. In one embodiment, the surface treatment can be performed by closing the microvalve and flushing dilute hydroxypropyl cellulose through the separation channel.

In some embodiments, the methods of the present invention include improved surface treatments for preconcentrating and separating positively charged species or cationic analytes. For preconcentration of positively charged species, pre-treatment of the device or the microvalve surface is done prior to preconcentration. That is, the surface of the microvalve is coated with a polycationic polymer and then the device is baked at a temperature range of approximately 100 to 150° C. FIG. 20 shows MS signal intensity of leucine enkephalin vs. concentrating time.

The present invention also discloses improved coupling with capillary-based separations. In this embodiment, sample preconcentration on a microfluidic device is coupled with capillary electrophoresis. It has been found that by inserting a tapered or etched capillary directly into the microchannels, dead volume is avoided.

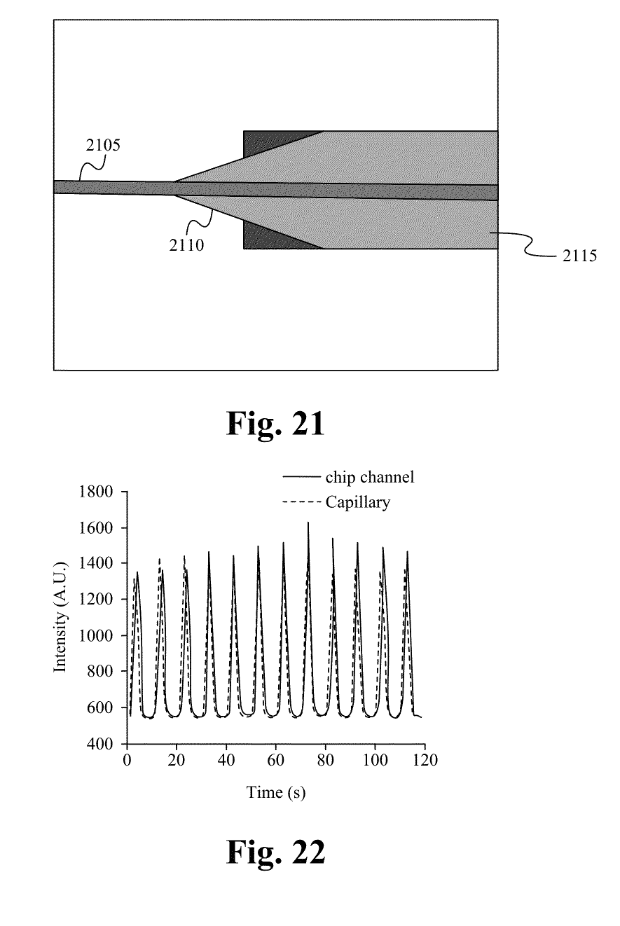

FIG. 21 is a photomicrograph of an etched capillary inserted into a microchannel, in accordance with one embodiment of the present invention. The photomicrograph of FIG. 21 shows a microchannel 2105 and a capillary 2115. A capillary holder is coupled to one end of the microchannel 2105, and the capillary 2115 is inserted into the microchannel 2105. An end of the capillary 2115 is tapered 2110, and the end of the capillary 2115 is etched and coupled to the microchannel 2105. As a result, the interface between the microchannel 2105 and the capillary 2115 is free of dead volume. The other end of the capillary 2115 is coupled to a detector, such as MS or an ESI emitter for MS, for detection.

In one embodiment, the capillary 2115 has the same size of the microchannel 2105, with one end etched with HF. The etched or tapered end was inserted into the microchannel 2105 and automatically sealed after insertion.

FIG. 22 is a comparison of peak widths before and after a peak passes from the microchannel to the capillary of FIG. 21.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method of preconcentrating analytes at a microvalve in a microfluidic device comprising:
a. loading a sample solution into a sample channel, wherein the sample channel includes a semi-permeable membrane microvalve;
b. applying an electric voltage at or across the microvalve to preconcentrate the sample solution when the microvalve is closed;
c. introducing the sample solution to a separation channel when the microvalve is opened, wherein the separation channel is coupled to a capillary holder; and
d. positioning a tapered or etched end of a capillary into the separation channel such that the interface between the capillary and the separation channel is free of dead volume.

2. The method of claim 1 wherein a concentration of the sample solution is less than about 100 millimolars.

3. The method of claim 1 wherein the microvalve is pressure actuated, mechanically actuated, or electrically actuated.

4. The method of claim 1 wherein the sample solution is simultaneously preconcentrated in the sample channel and separated in the separation channel when the microvalve is closed.

5. The method of claim 4 wherein the sample channel intersects the separation channel in a T-junction configuration.

6. The method of claim 5 further comprising providing a control channel, wherein the control channel crosses the sample channel at an intersection upstream of the T-junction intersection.

7. The method of claim 6 wherein the membrane microvalve is positioned at the intersection of the control and sample channels.

8. The method of claim 1 further comprising introducing a buffer solution into the separation channel along with the sample solution.

9. The method of claim 8 wherein a concentration of the buffer solution is between 1 and 500 millimolar.

10. The method of claim 1 further comprising coupling at least one of the following to, and upstream of, the sample channel: a liquid chromatography (LC) column, a capillary for capillary electrophoresis (CE), a capillary LC column for high-pressure liquid chromatography (HPLC), and a tip for electrospray ionization (ESI).

11. The method of claim 1 further comprising coupling an electrospray ionization (ESI) source downstream of the separation channel and the capillary.

12. The method of claim 1 wherein the applied voltage at or across the membrane is between 1 and 5000 volts.

13. The method of claim 1 wherein the membrane has a thickness of less than 100 micrometers.

14. A system for preconcentrating analytes at a microvalve in a microfluidic device comprising:
a. a sample channel loaded with a sample solution, wherein the sample channel includes a semi-permeable membrane microvalve, wherein an electrical voltage is applied at or across the microvalve to preconcentrate the sample solution when the microvalve is closed;
b. a separation channel coupled downstream of the sample channel, wherein the sample solution is introduced into the separation channel when the microvalve is opened; and
c. a capillary holder coupled to the separation channel, for positioning a tapered or etched end of a capillary into the separation channel such that the interface between the capillary and the separation channel is free of dead volume.

15. The system of claim 14 wherein a concentration of the sample solution is less than about 100 millimolars.

16. The system of claim 14 wherein the microvalve is pressure actuated, mechanically actuated, or electrically actuated.

17. The system of claim 14 wherein the sample channel intersects the separation channel in a T-junction configuration.

18. The system of claim 17 further comprising a control channel that crosses the sample channel at an intersection upstream of the T-junction intersection.

19. The system of claim 18 wherein the membrane microvalve is positioned at the intersection of the control and sample channels.

20. The system of claim 14 further comprising a buffer solution that is introduced into the separation channel along with the sample solution.

21. The system of claim 20 wherein a concentration of the buffer solution is between 1 and 500 millimolar.

22. The system of claim 14 further comprising at least one of the following coupled to, and upstream of, the sample channel: a (LC) column, a capillary for CE, a capillary LC column for HPLC, and a tip for ESI.

23. The system of claim 14 further comprising an ESI source coupled downstream of the separation channel and capillary.

24. The system of claim 14 wherein the applied voltage at or across the membrane is between 1 and 5000 volts.

25. The system of claim 14 wherein the membrane has a thickness of less than 100 micrometers.

26. A method of preconcentrating cationic analytes at a semi-permeable membrane microvalve positioned in a sample channel of a microfluidic device comprising:
a. coating a surface of the microvalve with a polycationic polymer;
b. baking the device at a temperature range of approximately 100 to 150° C.;
c. loading a sample solution into the sample channel, wherein a concentration of the sample solution is less than about 100 millimolars; and
d. applying an electric voltage at or across the microvalve to preconcentrate the sample solution when the microvalve is closed.

27. The method of claim 26 further comprising introducing the sample solution to a separation channel when the microvalve is opened.

28. The method of claim 27 wherein the sample solution is simultaneously preconcentrated in the sample channel and separated in the separation channel when the microvalve is closed.

29. The method of claim 27 further comprising positioning a tapered or etched end of a capillary into the separation channel such that the interface between the capillary and the separation channel is free of dead volume.

30. A method of preconcentrating anionic analytes at a microvalve positioned in a sample channel of a microfluidic device comprising:
a. baking the device at a temperature range of approximately 100 to 150° C.;
b. loading a sample solution into the sample channel, wherein a concentration of the sample solution is less than about 100 millimolars; and
c. applying an electric voltage at or across the microvalve to preconcentrate the sample solution when the microvalve is closed.

31. The method of claim 30 further comprising introducing the sample solution to a separation channel when the microvalve is opened.

32. The method of claim 31 wherein the sample solution is simultaneously preconcentrated in the sample channel and separated in the separation channel when the microvalve is closed.

33. The method of claim 31 further comprising positioning a tapered or etched end of a capillary into the separation channel such that the interface between the capillary and the separation channel is free of dead volume.
